(19) United States
(12) Patent Application Publication
(10) Pub. No.: US 2005/0233190 A1
(43) Pub. Date: Oct. 20, 2005

(54) Fuel cell with removable/replaceable cartridge and method of making and using the fuel cell and cartridge

(76) Inventors: Gennadi Finkelshtain, Shoham (IL); Mark Estrin, Meuhad (IL); Moti Meron, Hrzeliya (IL); Eric Torgeman, Tel Aviv (IL)

Correspondence Address: GREENBLUM & BERNSTEIN, P.L.C., 1950 ROLAND CLARKE PLACE, RESTON, VA, 20191, US

(21) Appl. No.: 10/824,443

(22) Filed: Apr. 15, 2004

(51) Int. Cl. H01M 8/04; H01M 2/02; B65D 6/00

(52) U.S. Cl. 429/22; 429/34; 429/127; 220/4.12; 429/13

(57) ABSTRACT

System for refilling a fuel cell wherein the system includes a fuel cell having at least one variable volume chamber, a cartridge having at least one variable volume chamber, and a valve system which regulates or controls fluid flow between the cartridge and fuel cell and vice versa. A method of refilling a fuel cell provides for connecting the cartridge to the fuel cell and transferring fuel and electrolyte from the cartridge to the fuel cell. This Abstract is not intended to define the invention disclosed in the specification, nor intended to limit the scope of the invention in any way.

### BACKGROUND OF THE INVENTION

1. Field of the Invention

The present invention relates to a refillable liquid fuel cell. The invention also relates to a refilling device, e.g., a cartridge, for refilling a fuel cell which is connected to the fuel cell during its use. The present invention also relates to the combination of a fuel cell having one or more compartments for the electrodes and a cartridge having one or more liquid chambers which supplies and stores liquids for the fuel cell. The cartridge is capable of supplying fresh liquids to the fuel cell and also capable of removing the spent liquids from the fuel cell and storing them.

The invention also relates to a fuel cell having a flexible collapsing chamber and a cartridge having a flexible collapsing chamber, wherein the cartridge can be removed from and/or disconnected from the fuel cell as well as a method of making and using these devices.

The invention further relates to a fuel cell and cartridge which are attached to one another when fuel components are transferred from the cartridge to the fuel cell in a transfer phase, when the fuel cell is in use producing electricity in a working phase, and when the fuel components (i.e., spent fuel and electrolyte) are transferred back to the cartridge from the fuel cell in a fluid retraction phase.

2. Discussion of Background Information

Fuel cells produce electricity by bringing a fuel into contact with a catalytic anode. At the same time, an oxidant is brought into contact with a catalytic cathode. There are a lot of well-known problems with conventional fuel (H₂, CH₃OH) storage and transportation associated with fuel cells, especially in the field of portable fuels and fuel cells. As the fuel cell produces electricity, the liquid fuel and the electrolyte in a refillable liquid fuel cell are gradually exhausted of their useful components. After a period of use, the spent liquid fuel and the spent electrolyte need to be removed from the fuel cell and replaced. This process is not easily and/or economically accomplished. Refilling the fuel cell also presents other difficulties due to the hazardous nature of the spent liquid fuel and the spent electrolyte. Thus, there is a need for a system for refilling a refillable liquid fuel cell which allows one to perform the refilling process more easily, more economically, and more safely, and which can safely store the spent fuel once it is removed from the fuel cell.

### SUMMARY OF THE INVENTION

The invention thus provides for a fuel cell system comprising a fuel cell that includes at least one variable volume chamber, a cartridge that includes at least one variable volume chamber, and a valve system which regulates or controls fluid flow between the cartridge and fuel cell and vice versa.

The at least one variable volume chamber of the fuel cell may comprise a flexible fuel chamber. The system may further comprise a defined volume electrolyte chamber. The system may further comprise an electrolyte chamber. The at least one variable volume chamber of the cartridge may comprise a flexible fuel chamber. The at least one variable volume chamber of the cartridge may comprise a flexible fuel chamber and a flexible electrolyte chamber. The at least one variable volume chamber of the fuel cell may comprise a flexible wall having folds. The at least one variable volume chamber of the cartridge may comprise a flexible wall having folds. The at least one variable volume chamber of the fuel cell may comprise a flexible expandable and contractable chamber. The at least one variable volume chamber of the cartridge may comprise a flexible expandable and contractable chamber.

The cartridge may be removably connected to the fuel cell. The cartridge may be removably connected to the fuel cell by a sliding connection. The cartridge may be removably connected to the fuel cell by a sliding cradle connection. The cartridge may be removably connected to the fuel cell by an abutting connection. The cartridge may be removably connected to the fuel cell by a rotational sliding connection.

The fuel cell may further comprise a front cover, a rear cover, a mounting frame, an anode assembly, a cathode assembly, a cathode protection device, and a frame rim. The at least one variable volume chamber of the fuel cell may comprise a flexible wall having folds and a peripheral rim secured to the anode assembly. The cathode protection device may comprise a cathode protection net. The anode assembly and the cathode assembly may be mounted to the mounting frame and wherein a volume defined by the mounting frame, the anode assembly and the cathode assembly forms an electrolyte chamber. The at least one variable volume chamber of the fuel cell may comprise a flexible wall having folds and a peripheral rim secured to the anode assembly and wherein a volume defined by the flexible wall and the anode assembly forms the at least one variable volume chamber of the fuel cell.

The cartridge may further comprise a front cover and a rear cover. The at least one variable volume chamber of the cartridge may be disposed between the front cover and the rear cover.

The at least one variable volume chamber of the cartridge may comprise a backing and a flexible wall having folds and a peripheral portion secured to the backing. The backing may comprise a plate.

The at least one variable volume chamber of the cartridge may comprise a variable volume fuel chamber and a variable volume electrolyte chamber, and further comprising fuel arranged within the variable volume fuel chamber and electrolyte arranged within the variable volume electrolyte chamber.

The at least one variable volume chamber of the fuel cell may comprise a variable volume fuel chamber, and the fuel cell may further comprise an electrolyte chamber, fuel arranged within the variable volume fuel chamber, and electrolyte arranged within the electrolyte chamber.

The valve system may comprise a first part which is coupled to the fuel cell and a second part which is coupled to the cartridge. The second part may be insertable into the first part. The second part may be releasably connectable to the first part. When the second part is disconnected from the first part, the first part may prevent fluid from exiting out of the fuel cell and the second part prevents fluid from exiting out of the cartridge. When the second part is disconnected from the first part, the first part may prevent fluid from leaking out of the fuel cell and the second part prevents fluid from leaking out of the cartridge.

The valve system may comprise a closed position and an opened position. The valve system may comprise a plurality of exit ports which are in fluid communication with the fuel cell. The fuel cell and the cartridge may each comprise a generally rectangular shape.

The invention also provides for a method of assembling a cartridge to a fuel cell, wherein the method comprises connecting a cartridge comprising at least one variable volume chamber to a fuel cell comprising at least one variable volume chamber, and transferring fluid from the cartridge to the fuel cell.

The transferring may comprise regulating or controlling fluid flow between the cartridge and fuel cell. The transferring may comprise regulating or controlling fluid flow between the cartridge and fuel cell and vice versa.

The method may further comprise transferring spent fluid between the fuel cell and the cartridge. The method may further comprise controlling fluid flow between the cartridge and the fuel cell via a valve system. The method may further comprise controlling fluid flow between the fuel cell and the cartridge via a valve system.

The transferring may comprise compressing the least one variable volume chamber of the cartridge to cause the fluid to enter into the fuel cell. The fluid may comprise fuel and electrolyte. The transferring may comprise forcing the fluid to enter into the at least one variable volume chamber of the fuel cell from the at least one variable volume chamber of the cartridge. The at least one variable volume chamber of the fuel cell may comprise a flexible wall with folds. The at least one variable volume chamber of the cartridge may comprise a flexible wall with folds. The at least one variable volume chamber of the fuel cell may comprise a flexible expandable and contractable chamber. The at least one variable volume chamber of the cartridge may comprise a flexible expandable and contractable chamber.

The method may further comprise, before the transferring, coupling a valve of the cartridge to a valve of the fuel cell. The method may further comprise, before the transferring, causing each valve to open from a closed position to allow fluid communication between the cartridge and the fuel cell.

The method may further comprise controlling fluid flow between the cartridge and the fuel cell and vice versa with a valve arrangement. The method may further comprise, before the transferring, securely attaching a male valve portion on the cartridge to a female valve portion on the fuel cell.

The method may further comprise, after the transferring, transferring spent fluid from the fuel cell to the cartridge and disconnecting the cartridge from the fuel cell. The method may further comprise, after the disconnecting, connecting a new cartridge to the fuel cell.

The invention also provides for a cartridge for refilling a fuel cell, wherein the cartridge comprises a main container, at least one variable volume fuel chamber and at least one variable volume electrolyte chamber arranged within the main container, and a valve that communicates with the at least one variable volume fuel and electrolyte chambers.

The main container may comprise a rear cover and a front cover. The at least one variable volume fuel chamber may comprise an flexible material wall that is at least one of expandable and compressible and inflatable and deflatable. The at least one variable volume electrolyte chamber may comprise an flexible material wall that is at least one of expandable and compressible and inflatable and deflatable. The at least one variable volume fuel chamber may be defined by an inflatable and/or expandable flexible material wall and a rigid plate. The at least one variable volume electrolyte chamber may be defined by another inflatable and/or expandable flexible material wall and the rigid plate.

The at least one variable volume electrolyte chamber may be defined by an inflatable and/or expandable flexible material wall and a rigid plate. The at least one variable volume fuel chamber may comprise a flexible material wall with folds. The at least one variable volume electrolyte chamber may comprise a flexible material wall with folds. The main container may completely surround and contain the at least one variable volume fuel chamber and the at least one variable volume electrolyte chamber. The at least one variable volume fuel chamber and the at least one variable volume electrolyte chamber may be separated from each other.

The cartridge may further comprise fuel arranged within the at least one variable volume fuel chamber and electrolyte arranged within the at least one variable volume electrolyte chamber.

The valve may be adapted to prevent fuel and electrolyte from exiting the at least one variable volume fuel chamber and the at least one variable volume electrolyte chamber when the cartridge is separated from the fuel cell, and the valve may be adapted to allow fuel and electrolyte to exit from the at least one variable volume fuel chamber and the at least one variable volume electrolyte chamber when the cartridge is connected to the fuel cell.

The valve may be adapted to prevent fuel and electrolyte from exiting the at least one variable volume fuel chamber and the at least one variable volume electrolyte chamber when the valve is disconnected from a valve of the fuel cell, and the valve may be adapted to allow fuel and electrolyte to exit from the at least one variable volume fuel chamber and the at least one variable volume electrolyte chamber when the valve of the cartridge is connected to the valve of the fuel cell.

The valve may be adapted to connect to and disconnect from a valve of the fuel cell. The valve may comprise a closed position and an opened position. The valve may comprise a plurality of exit ports which are adapted for fluid communication with the fuel cell.

The cartridge may further comprise a securing cap that is removably secured to the valve.

The invention also provides for a fuel cell adapted to connect to a cartridge, wherein the fuel cell comprises an outer shell, at least one variable volume fuel chamber and at least one electrolyte chamber arranged within the outer shell, an anode arranged within the outer shell, a cathode arranged within the outer shell, and a valve that communicates with the at least one variable volume fuel and electrolyte chambers.

The outer shell may comprise a rear cover and a front cover. The at least one variable volume fuel chamber may comprise an flexible material wall that is at least one of expandable and compressible and inflatable and deflatable. The at least one electrolyte chamber may comprise a defined volume chamber. The at least one variable volume fuel chamber may be defined by an inflatable and/or expandable flexible material wall and a rigid plate member. The rigid plate member may comprise the anode. The at least one electrolyte chamber may be defined by the cathode. The at least one electrolyte chamber may be defined by the cathode and a frame member.

The at least one variable volume fuel chamber may comprise a flexible material wall with folds. The fuel cell may further comprise a frame member supporting the anode and the cathode. The outer shell may completely surround and contain the at least one variable volume fuel chamber and the at least one electrolyte chamber. The at least one variable volume fuel chamber and the at least one electrolyte chamber may be separated from each other.

The fuel cell may further comprise fuel arranged within the at least one variable volume fuel chamber and electrolyte arranged within the at least one electrolyte chamber.

The valve may be adapted to prevent fuel and electrolyte from exiting the at least one variable volume fuel chamber and the at least one electrolyte chamber when the fuel cell is separated from a cartridge, and the valve may be adapted to allow fuel and electrolyte to exit from the at least one variable volume fuel chamber and the at least one electrolyte chamber when the cartridge is connected to the fuel cell.

The valve may be adapted to prevent fuel and electrolyte from exiting the at least one variable volume fuel chamber and the at least one electrolyte chamber when the valve is disconnected from a valve of the cartridge, and the valve may be adapted to allow fuel and electrolyte to exit from the at least one variable volume fuel chamber and the at least one electrolyte chamber when the valve of the cartridge is connected to the valve of the fuel cell.

The valve may be adapted to connect to and disconnect from a valve of the cartridge. The valve may comprise a closed position and an opened position. The valve may comprise a plurality of exit ports which are adapted for fluid communication with the cartridge.

The fuel cell may further comprise a securing cap that is removably secured to the valve.

The invention also provides for a fuel cell and cartridge system, wherein the system comprises a fuel cell and a cartridge. The fuel cell comprises an anode, a cathode, at least one variable volume fuel chamber, at least one electrolyte chamber, and a first valve which regulates or controls fluid flow. The cartridge comprises at least one variable volume fuel chamber, at least one variable volume electrolyte chamber, and a second valve which regulates or controls fluid flow. The second valve is removably connectable to the first valve.

The fuel cell may comprise an outer shell having a rear cover and a front cover. Each at least one variable volume fuel chamber may comprise an flexible material wall that is at least one of expandable and compressible and inflatable and deflatable. The at least one electrolyte chamber of the fuel cell may comprise a defined volume chamber.

Each at least one variable volume fuel chamber may be defined by an inflatable and/or expandable flexible material wall and a rigid plate member. The at least one electrolyte chamber of the fuel cell may be defined by the cathode and a frame member.

Each at least one variable volume fuel chamber may comprise a flexible material wall with folds.

The system may further comprise a frame member supporting the anode and the cathode of the fuel cell.

The fuel cell may further comprise an outer shell that completely surrounds and contains the at least one variable volume fuel chamber and the at least one electrolyte chamber. The cartridge may further comprise a main container that completely surrounds and contains the at least one variable volume fuel chamber and the at least one variable volume electrolyte chamber. The at least one variable volume fuel chamber and the at least one electrolyte chamber of the fuel cell may be separated from each other, and the at least one variable volume fuel chamber and the at least one variable volume electrolyte chamber of the cartridge may be separated from each other.

The system may further comprise fuel arranged within the at least one variable volume fuel chamber and electrolyte arranged within the at least one electrolyte chamber of the fuel cell.

The system may further comprise fuel arranged within the at least one variable volume fuel chamber and electrolyte arranged within the at least one variable volume electrolyte chamber of the cartridge.

The first valve may be adapted to prevent fuel and electrolyte from exiting the at least one variable volume fuel chamber and the at least one electrolyte chamber when the fuel cell is separated from the cartridge, and the second valve may be adapted to allow fuel and electrolyte to exit from the at least one variable volume fuel chamber and the at least one variable volume electrolyte chamber of the cartridge when the cartridge is connected to the fuel cell. The first valve may be adapted to prevent fuel and electrolyte from exiting the at least one variable volume fuel chamber and the at least one electrolyte chamber when the first valve is disconnected from the second valve of the cartridge, and the first valve may be adapted to allow fuel and electrolyte to exit from the at least one variable volume fuel chamber and the at least one electrolyte chamber when the second valve of the cartridge is connected to the first valve of the fuel cell.

The first valve of the fuel cell may be adapted to connect to and disconnect from the second valve of the cartridge. Each of the first and second valves may comprise a closed position and an opened position. Each of the first and second valves may comprise a plurality of exit ports which are adapted for fluid flow.

The system may further comprise a first securing cap that is removably secured to the first valve and a second securing cap that is removably secured to the second valve. The first valve may be securely and sealingly connected to second valve.

The invention also provides for a method of refilling a fuel cell using the system described above, wherein the method comprises connecting the second valve of the cartridge to the first valve of the fuel cell, forcing fuel to enter into the at least one variable volume fuel chamber of the fuel cell from the at least one variable volume fuel chamber of the cartridge, and forcing electrolyte to enter into the at least one electrolyte chamber of the fuel cell from the at least one variable volume electrolyte chamber of the cartridge.

Each forcing may comprise compressing the at least one variable volume fuel chamber and the at least one variable volume electrolyte chamber to cause fuel and electrolyte to enter into the fuel cell.

The method may further comprise controlling fluid flow between the fuel cell and cartridge with the first and second valves.

The method may further comprise controlling fluid flow between the fuel cell and the cartridge with the first and second valves.

The method may further comprise forcing fuel to enter into the at least one variable volume fuel chamber of the cartridge from the at least one variable volume fuel chamber of the fuel cell, forcing electrolyte to enter into the at least one variable volume electrolyte chamber of the cartridge from the at least one electrolyte chamber of the fuel cell, disconnecting the second valve from the first valve, and preventing, with the second valve, spent fuel and electrolyte from exiting the cartridge.

The invention also provides for a method of refilling a fuel cell with a removable cartridge, wherein the method comprises connecting the cartridge and the fuel cell to each other and transferring at least one fuel component from the cartridge to the fuel cell.

The method may further comprise transferring the at least one fuel component from the fuel cell to the cartridge and disconnecting the cartridge from the fuel cell.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows an exploded view of one non-limiting embodiment of a fuel cell and cartridge for refilling a fuel cell. This embodiment uses a cartridge that includes separate fuel and electrolyte supply chambers;

FIG. 2 shows an enlarged exploded view of the fuel cell shown in FIG. 1;

FIG. 3 shows an enlarged exploded view of the cartridge shown in FIG. 1;

FIG. 4 shows a perspective cross-section view of the embodiment shown in FIG. 1. The fuel cell is shown on the left while the cartridge is shown on the right. In this position, the cartridge and fuel cell are disconnected from each other and the cartridge contains the fresh fuel and electrolyte;

FIG. 5 shows an enlarged view of the circled portion in FIG. 4;

FIG. 6 shows another perspective cross-section view of the embodiment shown in FIG. 1. The fuel cell is shown on the left while the cartridge is shown on the right. In this position, the cartridge and fuel cell are disconnected from each other and the cartridge contains the fresh fuel and electrolyte;

FIG. 7 shows a perspective cross-section view of the embodiment shown in FIG. 1. The fuel cell is shown on the left while the cartridge is shown on the right. In this position, the cartridge and fuel cell are arranged just prior to being connected to each other. The cartridge contains the fresh fuel and electrolyte which will be pumped into the fuel cell after the cartridge is inserted into the fuel cell;

FIG. 8 shows an enlarged view of the circled portion in FIG. 7;

FIG. 9 shows another perspective cross-section view of the embodiment shown in FIG. 1. The fuel cell is shown on the left while the cartridge is shown on the right. In this position, the cartridge and fuel cell are arranged just prior to being connected to each other. The cartridge contains the fresh fuel and electrolyte which will be pumped into the fuel cell after the cartridge is inserted into the fuel cell;

FIG. 10 shows a perspective cross-section view of the embodiment shown in FIG. 1. The fuel cell is shown on the left while the cartridge is shown on the right. In this position, the cartridge and fuel cell are fully connected to each other. The cartridge continues to contain the fresh fuel and electrolyte;

FIG. 11 shows an enlarged view of the circled portion in FIG. 10;

FIG. 12 shows another perspective cross-section view of the embodiment shown in FIG. 1. The fuel cell is shown on the left while the cartridge is shown on the right. In this position, the cartridge and fuel cell are fully connected to each other. The cartridge continues to contain the fresh fuel and electrolyte;

FIG. 13 shows a perspective cross-section view of the embodiment shown in FIG. 1. The fuel cell is shown on the left while the cartridge is shown on the right. In this position, the cartridge and fuel cell are fully connected to each other and the fresh fuel and electrolyte have been pumped from the cartridge to the fuel cell;

FIG. 14 shows an enlarged view of the circled portion in FIG. 13;

FIG. 15 shows another perspective cross-section view of the embodiment shown in FIG. 1. The fuel cell is shown on the left while the cartridge is shown on the right. In this position, the cartridge and fuel cell are fully connected to each other and the fresh fuel and electrolyte have been pumped from the cartridge to the fuel cell;

FIG. 16 shows another non-limiting embodiment of a fuel cell and cartridge arrangement. This embodiment uses a cartridge which slides into connection with the fuel cell from a vertical position. This embodiment also uses separate fuel and electrolyte supply chambers;

FIG. 17 shows another non-limiting embodiment of a fuel cell and cartridge arrangement. This embodiment uses a cartridge which slides onto the fuel cell from a horizontal position. This embodiment also uses separate fuel and electrolyte supply chambers;

FIG. 18 shows another non-limiting embodiment of a fuel cell and cartridge arrangement. This embodiment uses a cartridge which slides onto the fuel cell from a horizontal position and which rotates from an angled position to the vertical position. This embodiment also uses separate fuel and electrolyte supply chambers;

FIG. 19 shows a view of the embodiment of FIG. 18 with the cartridge in the angled position prior to being connected to the fuel cell and rotated to the vertical position;

FIG. 20a shows a partial view of the outer portions of the valve sleeves arranged adjacent to one another;

FIG. 20b shows a first spring and plunger valve which is utilized in the fuel cell valve;

FIG. 20c shows a second spring and ball valve which is utilized in the cartridge valve;

FIG. 20d shows a partial view of the two valves in an assembled state prior to being connected to each other; and

FIG. 20e shows a partial view of the two valves in a connected state and in a state which allows for fluid communication between the cartridge and fuel cell and vice versa.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

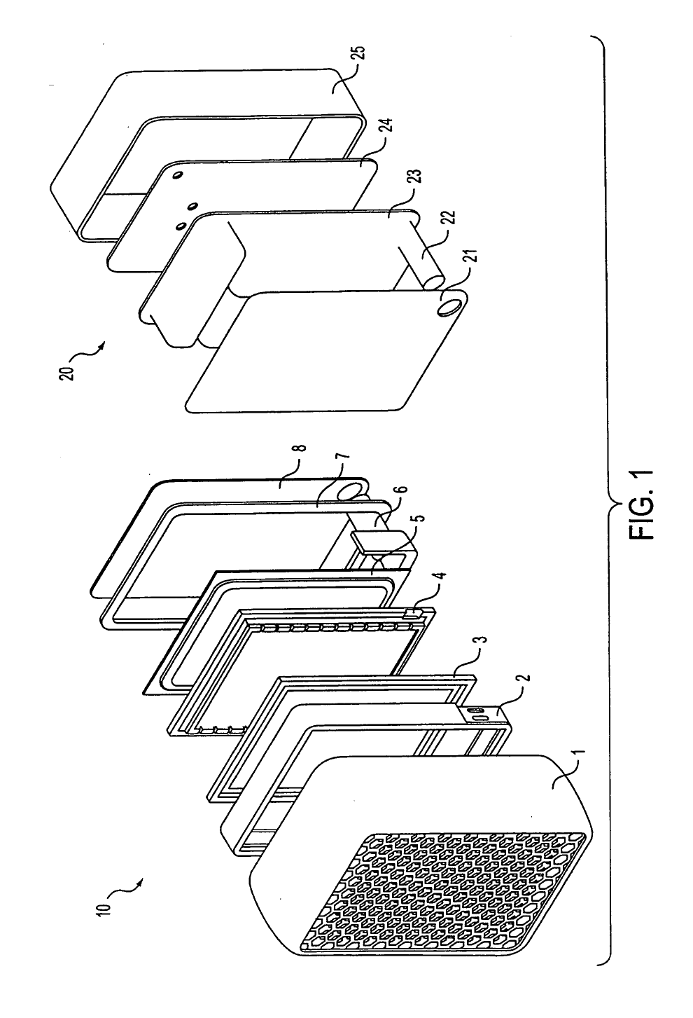

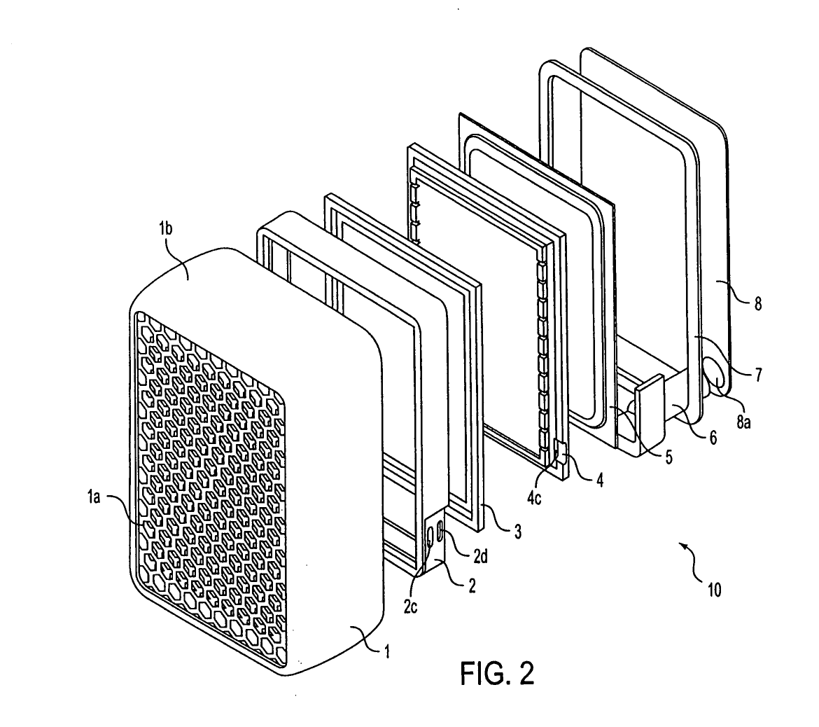

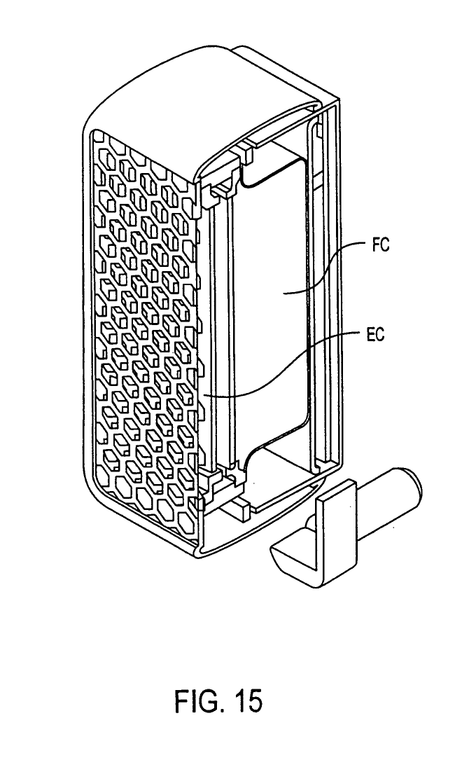

FIGS. 1-15 show a first non-limiting embodiment of a fuel cell 10 and cartridge 20 arrangement and/or system. The fuel cell 10 includes a front cover 1 and is generally rectangular in shape. Of course, the fuel cell 10 can have any other desired shape including, but not limited to any other polygonal or any other linear and/or curvilinear shape. The front cover 1 functions as a support frame for the internal components 2-8, and together with the rear cover 8, defines a fuel cell enclosure. As can be seen in, e.g., FIG. 2, the front cover 1 includes an outer peripheral wall 1b and a cathode protection net 1a which is fixed to an outer perforated surface of the cover 1. An electrode frame member 2 is mounted and/or fixed within the front cover 1. The frame 2 is generally rectangular in shape. Of course, the frame 2 can have any other desired shape. The frame 2 functions as a support frame for inner and outer electrodes.

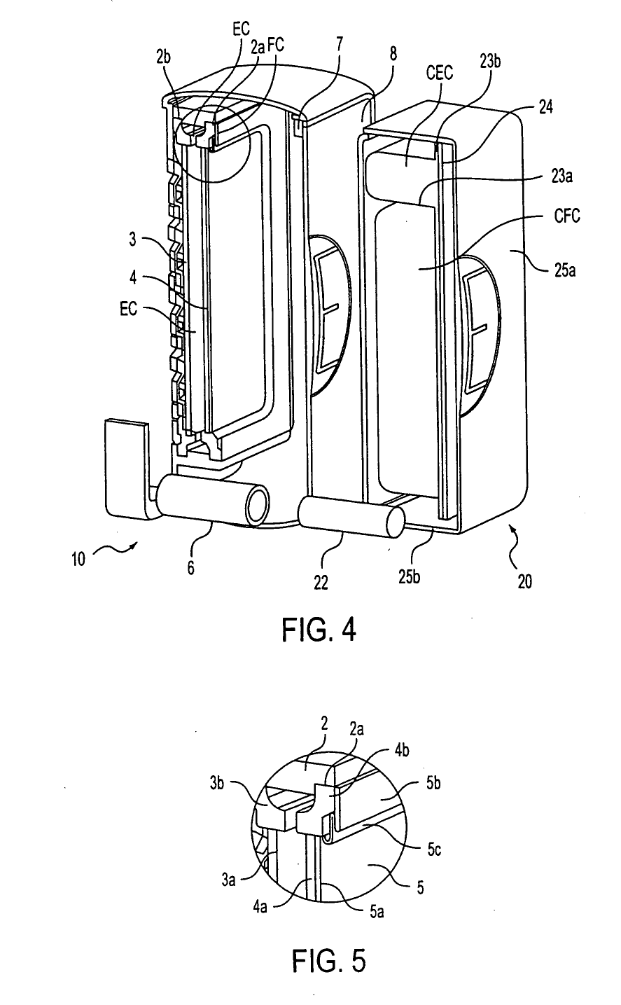

The outer electrode constitutes a cathode member 3 while the inner electrode constitutes an anode member 4. As can be seen in FIGS. 4 and 5, the cathode member 3 includes a cathode plate member 3a that is mounted within a peripheral rim member 3b, both of which are generally rectangular in shape. The rim portion 3b, in turn, is mounted within the frame 2. The anode member 4 includes an anode plate member 4a that is mounted within a peripheral rim member 4b, both of which are generally rectangular in shape. The rim portion 4b is similarly mounted within the frame 2. In this regard, the frame 2 includes an outer internal peripheral shoulder wall 2b which receives therein, in a sealing and/or press fit manner, the peripheral rim member 3b of the cathode member 3, as well as an opposite facing inner internal peripheral shoulder wall 2a which receives therein, in a sealing and/or press fit manner, the peripheral rim member 4b of the anode member 4. The arrangement of the cathode member 3, anode member 4 and frame 2 is such that they define an internal volume and/or space which forms a defined volume electrolyte chamber EC. The electrolyte chamber EC can be filled with electrolyte via one or more openings 2c (see FIG. 2).

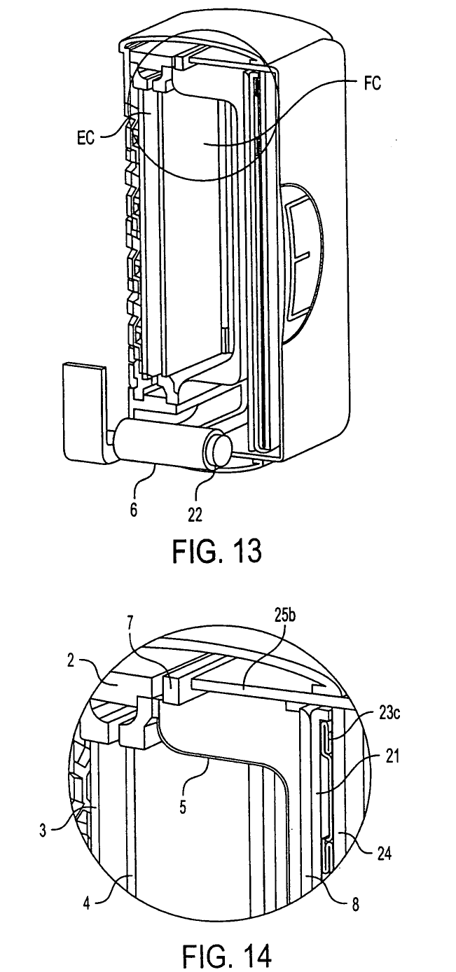

A flexible material member 5 includes a flexible expandable/inflatable wall 5a, one or more peripheral flexible folds 5c and a peripheral portion 5b (see FIG. 5). The flexible material 5 may be made of LLDPE (linear low density PE). Alternatively, the flexible material 5 may be a hot formed flat multiplayer polymer film. In this case, one or more outer layers may have a melting temperature that will substantially meet equal the part of the it will be heat welded to, RF welded to, or ultrasonically welded to (such a weld joint can be provided between portions 4b and 5b in FIG. 5). The flexible member 5 can be made as a one-piece member. Alternatively, the wall 5a and folds 5c can be formed as a one-piece member and securely and sealingly attached to a separately formed peripheral portion 5b using, e.g., adhesive bonding, ultrasonic welding, etc. As can be seen in FIGS. 4 and 5, the peripheral portion 5b of the flexible material member 5 is securely and sealingly attached to the peripheral rim member 4b and is also generally rectangular in shape. The rim 5b may be up to approximately 1 mm thick, while the remaining flexible or freely expandable portion(s) 5c, 5a may be approximately 0.3 mm thick. The rim member 4b may be made of ABS 5-20% carbon filled and/or may include a mechanical cavity imbedded into it in the area of the weld joint. This cavity can be filled and/or injected with PE using a consecutive injection process. Such an imbedded polymer rim 4b would facilitate attachment to the rim 5b of the flexible member 5. The arrangement of the anode member 4 and flexible material member 5 is such that they define an internal volume and/or space which forms a variable volume fuel chamber FC. The fuel chamber FC can be filled with fuel via one or more openings 2d in the frame 2, as well as one or more through openings 4c (which are aligned with openings 2d) in the rim 4b of the anode member 4 (see FIG. 2). The fuel chamber FC is a variable volume chamber by virtue of the flexible wall 5a and peripheral folds 5c. In this way, the variable volume fuel chamber FC constitutes and/or functions as a flexible expandable and contractable chamber which can expand when filled and/or inflated with fuel (see FIGS. 13-15) and which can contract when the fuel is removed therefrom (see FIGS. 4, 6, 7, 9, 10 and 12).

A movable rim member 7 arranged to move within the front cover 1. The rim member 7 is generally rectangular in shape and functions as a filler member to produce a gap or spacing (and thereby prevent contact) between member 2 and 25. For example, FIGS. 13 and 14 show a travel range of the member 7 and illustrates how the member 7 prevents the wall 25b from contacting member 2. The rim member 7 and rear plate 8 can each be made as a one-piece members. As can be seen in FIG. 2, the rear plate 8 includes an opening 8a which is sized to receive therein a valve 6. The valve 6 is configured to allow electrolyte and fuel to enter (separately from each other) into the fuel cell 10 and is also configured to mate with a valve 22 of a cartridge 20. In this regard, the valve 6 includes openings (as will be explained in detail later on) which communicate with openings 2c and 2d of the frame 2 to allow fuel and electrolyte to enter into the electrolyte chamber EC and the variable volume fuel chamber FC of the fuel cell 10. Although not shown, the invention contemplates fuel cells with more than one electrolyte chamber EC and more than one variable fuel chamber FC. This can be accomplished by using additional anode, cathode and frame arrangements, as well as additional anode and flexible material member arrangements. Alternatively, the electrolyte chamber EC can be made up of a plurality of smaller electrolyte sub-chambers which may or may not be in fluid communication with each other, but which would be in fluid communication with the valve 6. Similarly, the fuel chamber FC can be made up of a plurality of smaller fuel sub-chambers which may or may not be in fluid communication with each other, but which would be in fluid communication with the valve 6.

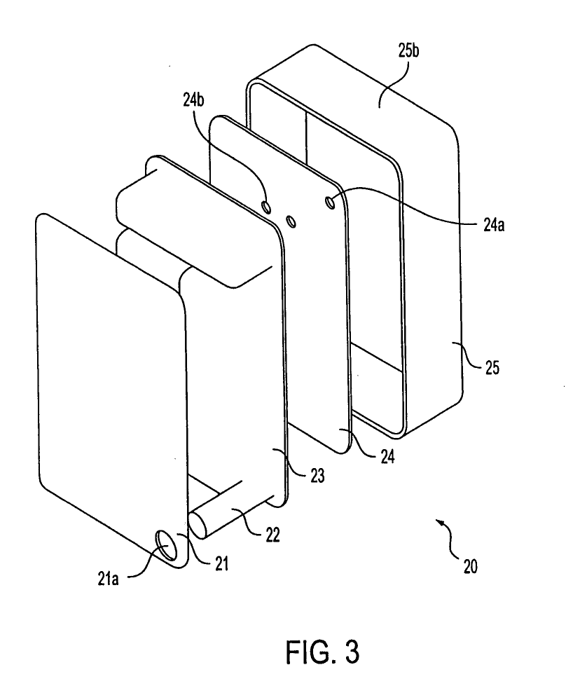

The cartridge 20 is also generally rectangular in shape. Of course, the cartridge 20 can have any other desired shape. The cartridge 20 has the form of an enclosure and includes a movable front cover plate 21 and a rear cover 25. The rear cover 25 functions as a support frame for the internal components 23 and 24 and together with the front cover 21 defines a cartridge enclosure. As can be seen in, e.g., FIGS. 3 and 4, the rear cover 25 includes an outer peripheral wall 25b and a rear wall 25a. A peripheral portion 23b of a flexible material wall 23a is mounted and/or fixed in a sealing manner to the cover plate 24. The plate 24 is generally rectangular in shape. Of course, the plate 24 can have any other desired shape. The plate 24 functions as a rigid support for the flexible wall 23a. The arrangement of the flexible member 23 and plate 24 is such that they define two separate internal volumes and/or spaces which form a variable volume cartridge electrolyte chamber CEC and a variable volume cartridge fuel chamber CFC. The electrolyte chamber CEC can be filled with electrolyte via one or more openings 24a in the plate 24 (see FIG. 3) while the fuel chamber CFC can be filled with fuel via one or more openings 24b in the plate 24 (see FIG. 3).

As noted above, the flexible material member 23 includes a flexible expandable/inflatable wall 23a which is secured to the plate 24 at various locations. The wall 23a includes one or more flexible folds 23c (see FIG. 14) for each variable volume chamber CEC, CFC. The flexible member 23 and folds 23c can be formed as a one-piece member and securely and sealingly attached to a separately formed plate 24 using, e.g., adhesive bonding, ultrasonic welding, etc. As can be seen in FIG. 4, the peripheral portion 23b as well as other portions of the flexible material member 23 are securely and sealingly attached to the plate 24 to define the variable volume chambers CEC and CFC. The flexible material 23 may be made of LLDPE (linear low density PE). Alternatively, the flexible material 23 may be a hot formed flat multiplayer polymer film. In this case, one or more outer layers may have a melting temperature that will substantially meet equal the part of the it will be heat welded to, RF welded to, or ultrasonically welded to (such a weld joint can be provided between portions 23b and 24 in FIG. 4). The arrangement of the plate 24 and flexible material member 23 is such that they define one or more small internal volumes and/or spaces which form one or more variable volume electrolyte chambers CEC and one or more internal volumes and/or spaces which form one or more variable volume fuel chambers CFC. The fuel chamber CFC and electrolyte chamber CEC are thus variable volume chambers by virtue of the flexible wall 23 and the folds 23c. In this way, the variable volume fuel and electrolyte chambers CFC and CEC constitute and/or function as a flexible expandable and contractable chambers which can expand when filled and/or inflated with fuel and electrolyte (see FIGS. 4, 6, 7, 9, 10 and 12) and which can contract when the fuel and electrolyte are removed therefore (see FIGS. 13-15). The rim 5b may be up to approximately 1 mm thick, while the remaining flexible or freely expandable portion(s) 5c , 5a may be approximately 0.3 mm thick. The member 24 may be made of ABS 5-20% carbon filled and/or may include a mechanical cavity imbedded into its peripheral area or weld joint area. This cavity can be filled and/or injected with PE using a consecutive injection process. Such an imbedded polymer rim would facilitate attachment to the rim 23b of the flexible member 23.

As noted above, the movable plate member 21 is arranged to move within the rear cover 25. The plate 21 and rear cover 25 can each be made as one-piece members. As can be seen in FIG. 3, the plate 21 includes an opening 21a which is sized to receive therein a valve 22. The valve 22 is configured to allow electrolyte and fuel to enter (separately from each other) into the cartridge 20 and is also configured to mate with a valve 6 of the fuel cell 10. In this regard, the valve 22 includes openings (as will be explained in detail below) which communicate with openings 24a and 24b of the plate 24 to allow fuel and electrolyte to enter into the variable volume electrolyte chamber CEC and the variable volume fuel chamber CFC. Although not shown, the invention contemplates cartridges with more than one variable volume electrolyte chamber CEC and more than one variable fuel chamber CFC. This can be accomplished by using additional plates and flexible wall arrangements. Alternatively, the electrolyte chamber CEC can be made up of a plurality of smaller electrolyte sub-chambers which may or may not be in fluid communication with each other but which would be in fluid communication with the valve 22. Similarly, the fuel chamber CFC can be made up of a plurality of smaller fuel sub-chambers in any desired configuration which may or may not be in fluid communication with each other but which would be in fluid communication with the valve 22.

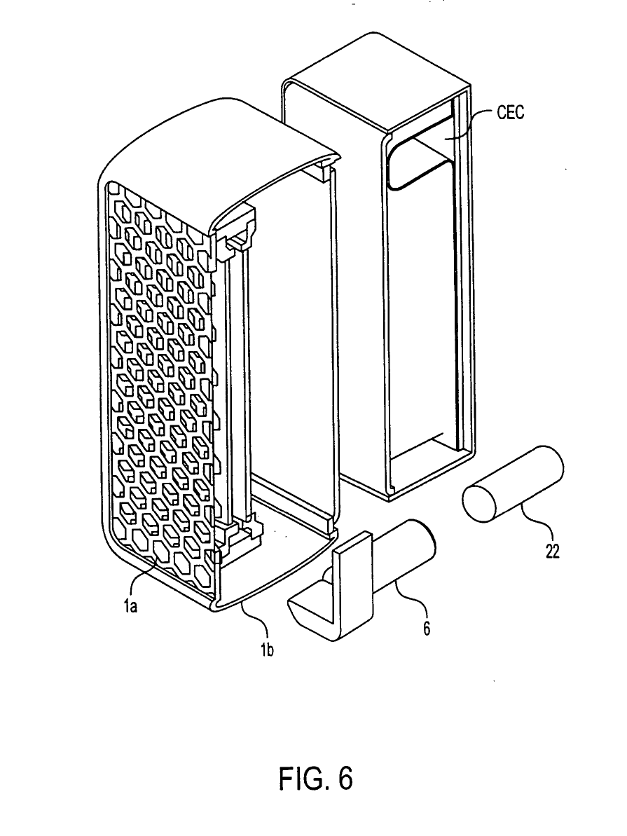

FIGS. 4 and 6 show the fuel cell 10 and the cartridge 20 in a position prior to the cartridge 20 being inserted into the fuel cell 10. At this point, the valve 22 of the cartridge 20 has also not mated with the valve 6 of the fuel cell 10. In this position, the cartridge 20 contains a substantially full and/or expanded electrolyte chamber CEC and a substantially full and/or expanded fuel chamber CFC. In the case of a new cartridge 20, these chambers CEC and CFC contain new or fresh electrolyte and fuel which is ready to be used and/or transferred to the fuel cell 10. The amounts of electrolyte and fuel contained in the cartridge 20 should generally correspond to the requirements of a particular fuel cell 10. Thus, the amount of electrolyte in the chamber CEC of the cartridge 20 should be sufficient to fill the chamber EC (up to a desired point) in the fuel cell 10 when the cartridge 20 is fully inserted and/or connected to the fuel cell 10 (see FIGS. 13-15). Similarly, the amount of fuel in the chamber CFC of the cartridge 20 should be sufficient to fill the chamber FC (up to a desired point) in the fuel cell 10 when the cartridge 20 is fully inserted and/or connected to the fuel cell 10 (see FIGS. 13-15). Of course, this may require that the chambers CEC and CFC of the cartridge 20 contain more electrolyte and fuel than can normally be accommodated in the chambers EC and FC in the fuel cell 10, owing to the fact that some fuel and electrolyte will be left in the valves 6 and 22, as well as in the fluid communication passages of both the fuel cell 10 and cartridge 20.

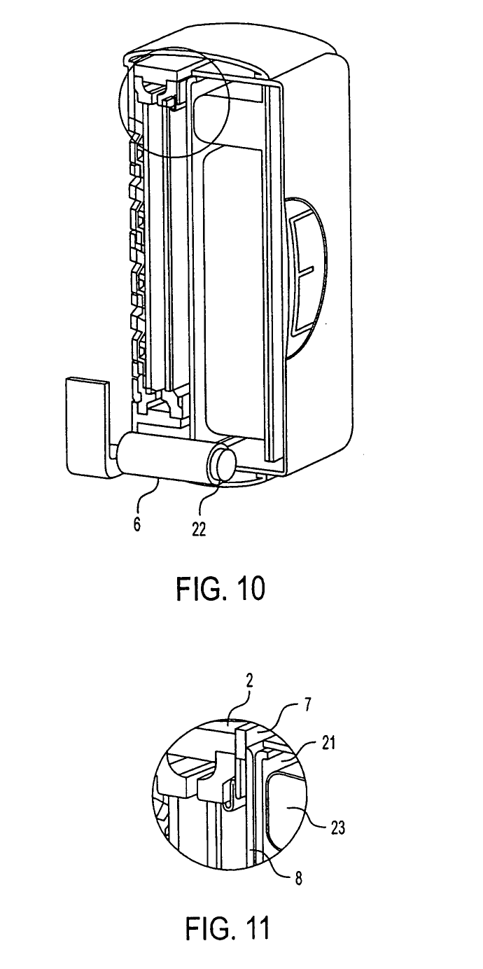

In the case of a new fuel cell 10, the electrolyte chamber EC and the variable volume fuel chamber FC are empty. In other words, the volume and/or space defined by the frame 2, cathode 3 and anode 4 is essentially empty of electrolyte and the fuel chamber FC is essentially in a fully deflated position and/or defines a lower volume limit (e.g., it has essentially zero volume because the flexible material member 5 is arranged closely adjacent to the anode member 4). This unconnected position is also characterized by the plate 21 being in a fully expanded position relative to the rear cover 25 of the cartridge 20, and by the plate 8 being in a fully expanded position and ready to move to a fully retracted position shown in FIGS. 10-12.

FIGS. 4 and 6 also illustrate the fuel cell 10 and the cartridge 20 in a position after the cartridge 20 has been completely disconnected from the fuel cell 10. At this point, the valve 22 of the cartridge 20 has been unmated and/or disconnected from the valve 6 of the fuel cell 10. In this position, the cartridge 20 contains a substantially full and/or expanded electrolyte chamber CEC and a substantially full and/or expanded fuel chamber CFC. In the case of a used cartridge 20, these chambers CEC and CFC contain spent electrolyte and fuel which has been used by fuel cell 10 to produce energy and which has thereafter been transferred from the fuel cell 10. The amounts of electrolyte and fuel contained in the cartridge 20 should generally correspond to the amounts of spent fuel remaining the fuel cell 10 after being utilized to produce energy for a specific period time and/or use. One would not normally need to disconnect the cartridge 20 from the fuel cell 10 unless there is a need to replace the fuel and electrolyte of the fuel cell 10 because, e.g., the energy production and/or efficiency of the fuel cell 10 has dropped below a desired level. Thus, the amount of electrolyte in the chamber CEC of the cartridge 20 after transfer will likely be insufficient to fill the chamber CEC, owing to losses (due to e.g., evaporation) which occur in the fuel cell 10. Similarly, the amount of fuel in the chamber CFC of the cartridge 20 after transfer will likely be insufficient to fill the chamber CFC, owing to losses (due to e.g., evaporation) which occur in the fuel cell 10. Of course, some small amount of spent fuel and electrolyte may remain in the fuel cell 10 after transfer, owing to the fact that some fuel and electrolyte will be left in the valve 6 and fluid communication passages of the fuel cell 10.

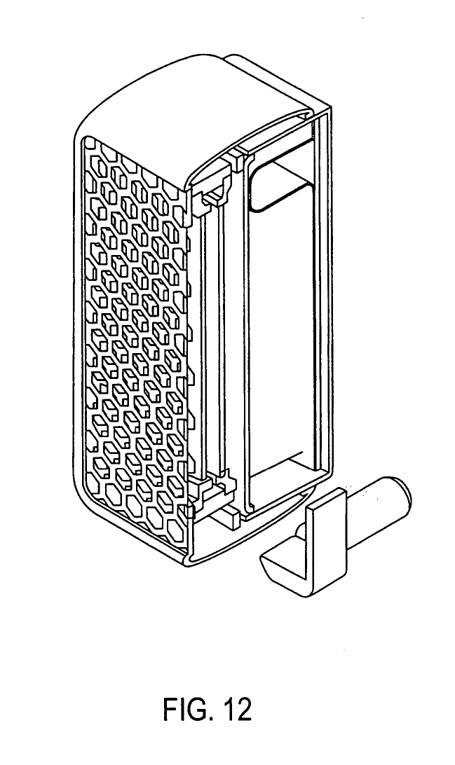

In the case of a used fuel cell 10 and cartridge 20, the electrolyte chamber EC and the variable volume fuel chamber FC are essentially empty after transfer while the spent fuel and electrolyte have been completely transferred to the chambers CEC and CFC of the cartridge 20 for disposal, safe-storage, refurbishing, refilling, etc. In other words, the volume and/or space defined by the frame 2, cathode 3 and anode 4 is essentially empty of electrolyte and the fuel chamber FC is essentially in a fully deflated position and/or defines a lower volume limit (e.g., it has essentially returned to a zero volume because the flexible material member 5 has moved back to a position closely adjacent to the anode member 4). This fully and completely disconnected position is also characterized by the plate 21 being in a fully expanded position relative to the rear cover 25 of the cartridge 20 and by the plate 8 having moved from the retracted position shown in FIG. 12 to the fully expanded position shown in FIGS. 4 and 6.

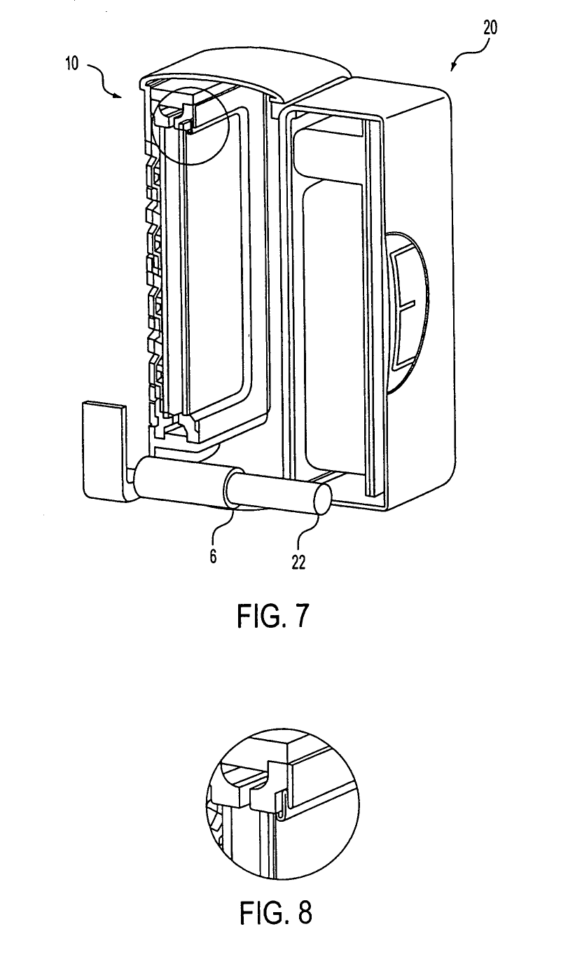

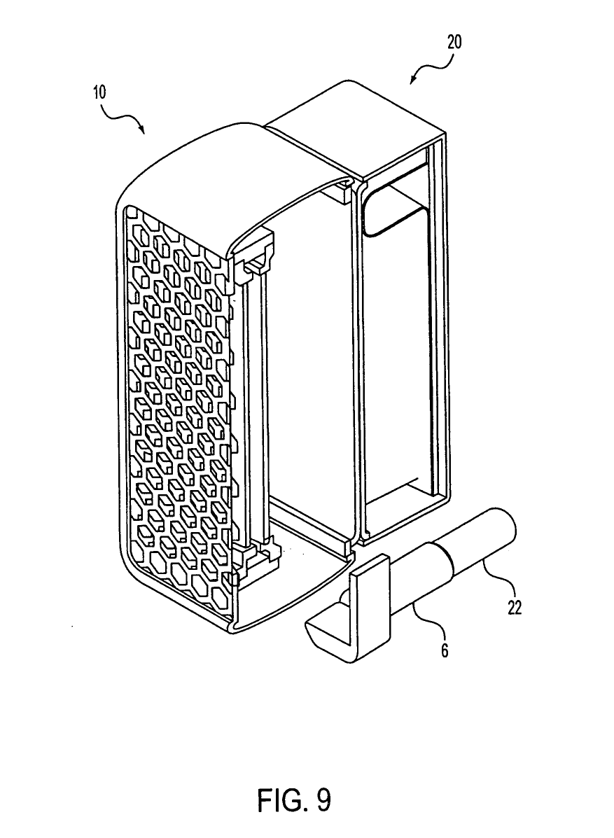

FIGS. 7 and 9 show the fuel cell 10 and the cartridge 20 in a position just prior to the cartridge 20 being inserted into the fuel cell 10. At this point, the valve 22 of the cartridge 20 has been aligned with the valve 6 of the fuel cell 10 and is ready for mating therewith. Moreover, the cartridge 20 body is also aligned with and in contact with the fuel cell 10 body and is otherwise ready for insertion therein. In this position, the cartridge 20 continues to contain a substantially full and/or expanded electrolyte chamber CEC and a substantially full and/or expanded fuel chamber CFC. In the case of a new cartridge 20, these chambers CEC and CFC contain new or fresh electrolyte and fuel which is ready to be used and/or transferred to the fuel cell 10. The amounts of electrolyte and fuel contained in the cartridge 20 should generally correspond to the requirements of a particular fuel cell 10. Thus, the amount of electrolyte in the chamber CEC of the cartridge 20 should be sufficient to fill the chamber EC (up to a desired point) in the fuel cell 10 when the cartridge 20 is fully inserted and/or connected to the fuel cell 10 (see FIGS. 13-15). Similarly, the amount of fuel in the chamber CFC of the cartridge 20 should be sufficient to fill the chamber FC (up to a desired point) in the fuel cell 10 when the cartridge 20 is fully inserted and/or connected to the fuel cell 10 (see FIGS. 13-15). Of course, as explained above, this may require that the chambers CEC and CFC of the cartridge 20 contain more electrolyte and fuel than can normally be accommodated in the chambers EC and FC in the fuel cell 10, owing to the fact that some fuel and electrolyte will be left in the valves 6 and 22 and fluid communication passages of both the fuel cell 10 and cartridge 20.

In the case of a new fuel cell 10, the electrolyte chamber EC and the variable volume fuel chamber FC continue to be empty. In other words, the volume and/or space defined by the frame 2, cathode 3 and anode 4 is essentially empty of electrolyte and the fuel chamber FC is essentially in a fully deflated position and/or defines a lower volume limit (e.g., it has essentially zero volume because the flexible material member 5 is arranged closely adjacent to the anode member 4). This pre-installation/insertion position is also characterized by the plate 21 being in a fully expanded position relative to the rear cover 25 of the cartridge 20, and by the plate 8 being in a fully expanded position and ready to in the move to a fully retracted position shown in FIG. 12.

FIGS. 7 and 9 also illustrate the fuel cell 10 and the cartridge 20 in a position after the cartridge 20 has been disconnected from the fuel cell 10. At this point, the valve 22 of the cartridge 20 has been unmated and/or disconnected from the valve 6 of the fuel cell 10, although the cartridge 20 and fuel cell 10 continue to be aligned with each other. In this position, the cartridge 20 contains a substantially full and/or expanded electrolyte chamber CEC and a substantially full and/or expanded fuel chamber CFC. In the case of a used cartridge 20, these chambers CEC and CFC contain spent electrolyte and fuel which has been used by fuel cell 10 to produce energy and which has thereafter been transferred from the fuel cell 10. As noted above, the amounts of electrolyte and fuel contained in the cartridge 20 should generally correspond to the amounts of spent fuel remaining the fuel cell 10 after being utilized to produce energy for a specific period time and/or use. One would not normally need to disconnect the cartridge 20 from the fuel cell 10 unless there is a need to replace the fuel and electrolyte of the fuel cell 10 because, e.g., the energy production and/or efficiency of the fuel cell 10 has dropped below a desired level. Thus, the amount of electrolyte in the chamber CEC of the cartridge 20 after transfer will likely be insufficient to fill the chamber CEC, owing to losses (due to e.g., evaporation) which occur in the fuel cell 10. Similarly, the amount of fuel in the chamber CFC of the cartridge 20 after transfer will likely be insufficient to fill the chamber CFC, owing to losses (due to e.g., evaporation) which occur in the fuel cell 10. Of course, some small amount of spent fuel and electrolyte may remain in the fuel cell 10 after transfer, owing to the fact that some fuel and electrolyte will be left in the valve 6 and the fluid communication passages of the fuel cell 10.

In the case of a used fuel cell 10 and cartridge 20, the electrolyte chamber EC and the variable volume fuel chamber FC are essentially empty after transfer while the spent fuel and electrolyte have been completely transferred to the chambers CEC and CFC of the cartridge 20 for disposal, safe-storage, refurbishing, refilling, etc. In other words, the volume and/or space defined by the frame 2, cathode 3 and anode 4 is essentially empty of electrolyte and the fuel chamber FC is essentially in a fully deflated position and/or defines a lower volume limit (e.g., it has essentially returned to a zero volume because the flexible material member 5 has moved back to a position closely adjacent to the anode member 4). This disconnected position is also characterized by the plate 21 being in a fully expanded position relative to the rear cover 25 of the cartridge 20 and by the plate 8 having moved from the retracted position shown in FIG. 12 to the fully expanded position shown in FIGS. 4 and 6.

FIGS. 10 and 12 show the fuel cell 10 and the cartridge 20 in a position after the cartridge 20 has been fully inserted into the fuel cell 10. At this point, the valve 22 of the cartridge 20 has been mated with the valve 6 of the fuel cell 10. Moreover, the plate 21 of the cartridge 20 body has forced the plate 8 and rim 7 of the fuel cell 10 to move to a fully retracted position adjacent the frame 2 and flexible member 5 from a fully expanded position shown in, e.g., FIGS. 4, 6, 7 and 9. In this position, the cartridge 20 continues to contain a substantially full and/or expanded electrolyte chamber CEC and a substantially full and/or expanded fuel chamber CFC. In the case of a new cartridge 20, these chambers CEC and CFC contain new or fresh electrolyte and fuel which is ready to be used and/or transferred to the fuel cell 10. Again, the amounts of electrolyte and fuel contained in the cartridge 20 should generally correspond to the requirements of a particular fuel cell 10. Thus, the amount of electrolyte in the chamber CEC of the cartridge 20 should be sufficient to fill the chamber EC (up to a desired point) in the fuel cell 10 when the cartridge 20 is fully inserted and/or connected to the fuel cell 10 and the electrolyte is transferred from the cartridge 20 to the fuel cell 10 (see FIGS. 13-15). Similarly, the amount of fuel in the chamber CFC of the cartridge 20 should be sufficient to fill the chamber FC (up to a desired point) in the fuel cell 10 when the cartridge 20 is fully inserted and/or connected to the fuel cell 10 and the fuel is transferred from the cartridge 20 to the fuel cell 10 (see FIGS. 13-15). Of course, as explained above, this may require that the chambers CEC and CFC of the cartridge 20 contain more electrolyte and fuel than can normally be accommodated in the chambers EC and FC in the fuel cell 10, owing to the fact that some fuel and electrolyte will be left in the valves 6 and 22 and the fluid communication passages of both the fuel cell 10 and cartridge 20 after transfer.

In the case of a new fuel cell 10, the electrolyte chamber EC and the variable volume fuel chamber FC continue to be empty in the position shown in FIGS. 10 and 12. In other words, the volume and/or space defined by the frame 2, cathode 3 and anode 4 is essentially empty of electrolyte and the fuel chamber FC is essentially in a fully deflated position and/or defines a lower volume limit (e.g., it has essentially zero volume because the flexible material member 5 is arranged closely adjacent to the anode member 4). This fully inserted and pre-fluid transfer position is also characterized by the plate 21 being in a fully expanded position relative to the rear cover 25 of the cartridge 20, and by the plate 8 and rim 7 being in a fully retracted position and ready to move to a partially expanded position shown in FIGS. 13-15.

FIGS. 10 and 12 also illustrate the fuel cell 10 and the cartridge 20 in a fully connected position after the cartridge 20 has received the spent fluids (i.e., spent fuel and electrolyte) from the fuel cell 10. At this point, the valve 22 of the cartridge 20 is fully mated and/or connected with the valve 6 of the fuel cell 10 and two-way fluid communication is possible between the cartridge 20 and fuel cell 10, owing to the valves 22 and 6 being opened. In this post-transfer position, the cartridge 20 contains a substantially full and/or expanded electrolyte chamber CEC and a substantially full and/or expanded fuel chamber CFC. In the case of a used cartridge 20, these chambers CEC and CFC contain spent electrolyte and fuel which has been used by fuel cell 10 to produce energy and which has been transferred from the fuel cell 10. As noted above, the amounts of electrolyte and fuel contained in the cartridge 20 should generally correspond to the amounts of spent fuel remaining the fuel cell 10 after being utilized to produce energy for a specific period time and/or use. One would not normally need to transfer fuel and electrolyte to the cartridge 20 from the fuel cell 10 unless there is a need to replace the fuel and electrolyte of the fuel cell 10 because of, e.g., the energy production and/or efficiency of the fuel cell 10 having dropped below a desired level. Thus, the amount of electrolyte in the chamber CEC of the cartridge 20 after transfer will likely be insufficient to fill the chamber CEC, owing to losses (due to e.g., evaporation) which occur in the fuel cell 10. Similarly, the amount of fuel in the chamber CFC of the cartridge 20 after transfer will likely be insufficient to fill the chamber CFC, owing to losses (due to e.g., evaporation) which occur in the fuel cell 10. Of course, some small amount of spent fuel and electrolyte may remain in the fuel cell 10 after transfer, owing to the fact that some small amount of fuel and electrolyte will remain within chambers EC and FC and will be left in the valve 6 and in the fluid communication passages of the fuel cell 10.

In the case of a used fuel cell 10 and cartridge 20, the electrolyte chamber EC and the variable volume fuel chamber FC are essentially empty after fluid transfer while the spent fuel and electrolyte have been completely transferred to the chambers CEC and CFC of the cartridge 20 for disposal, safe-storage, refurbishing, refilling, etc. In other words, the volume and/or space defined by the frame 2, cathode 3 and anode 4 is essentially empty of electrolyte and the fuel chamber FC is essentially in a fully deflated position and/or defines a lower volume limit (e.g., it has essentially returned to a zero volume because the flexible material member 5 has moved back to a position closely adjacent to the anode member 4). This post-fluid transfer position is also characterized by the plate 21 being in a fully expanded position relative to the rear cover 25 of the cartridge 20 and by the plate 8 and rim 7 having moved from the substantially expanded position shown in FIGS. 13-15 to the fully retracted position shown in FIGS. 10 and 12.

FIGS. 13-15 show the fuel cell 10 and the cartridge 20 in a position after the cartridge 20 has been fully inserted into the fuel cell 10 and after fluids have been transferred from the cartridge 20 to the fuel cell 10. At this point, the valve 22 of the cartridge 20 has been mated with the valve 6 of the fuel cell 10 and the valves 22 and 6 are opened to allow the fluids to flow from the cartridge 20 to the fuel cell 10. Moreover, the plate 21 of the cartridge 20 body has been forced by the plate 8 of the fuel cell 10 to move to a fully retraced position adjacent the plate 24 from a fully expanded position shown in, e.g., FIGS. 10 and 12. In the position shown in FIGS. 13-15, the fuel cell 10 now contains a substantially full electrolyte chamber EC and a substantially full and/or expanded fuel chamber FC. In the case of a new cartridge 20, the chambers CEC and CFC will have transferred the new or fresh electrolyte and fuel to the fuel cell 10 and the expansion of the fuel chamber FC will have caused and/or coincided with the deflation and/or collapse of the fuel and electrolyte chambers CFC and CEC of the cartridge 20. Again, the amounts of electrolyte and fuel contained in and transferred from the cartridge 20 should generally correspond to the requirements of a particular fuel cell 10. Thus, the amount of electrolyte in the chamber EC of the fuel cell 10 should be sufficient to fill the chamber EC (up to a desired point). Similarly, the amount of fuel in the chamber FC of the fuel cell 10 should be sufficient to fill the chamber FC (up to a desired point). Of course, as explained above, this may require that the chambers CEC and CFC of the cartridge 20 contain more electrolyte and fuel than can normally be accommodated in the chambers EC and FC in the fuel cell 10, owing to the fact that some fuel and electrolyte will be left in the valves 6 and 22 and fluid communication passages of both the fuel cell 10 and cartridge 20 after transfer.

In the case of a new fuel cell 10, the electrolyte chamber EC and the variable volume fuel chamber FC have now been filled in the position shown in FIGS. 13-15. In other words, the volume and/or space defined by the frame 2, cathode 3 and anode 4 is essentially full of electrolyte and the fuel chamber FC is essentially in a partially to fully inflated position and/or defines an upper volume limit (e.g., it has essentially a maximum desired volume because the flexible material member 5 is arranged at essentially a maximum position away from the anode member 4). This post-fluid transfer position is characterized by fluids being fully transferred from the cartridge 20 to the fuel cell 10 and is also characterized by the plate 21 being in a fully retracted position relative to the rear cover 25 of the cartridge 20, and by the plate 8 being in a fully expanded position and ready to move to a fully retracted position shown in FIGS. 10 and 12. It should be noted that in the position shown in FIGS. 13-15, the front edge of wall 25b of the rear cover 25 forces the rim 7 against the frame 2 and allows the plate 8 to move within it. Moreover, the valve 22 is fully inserted within the valve 6.

FIGS. 13-15 also illustrate the fuel cell 10 and the cartridge 20 in a fully connected position just prior to the fluids (i.e., spent fuel and electrolyte) being transferred from the fuel cell 10 to the cartridge 20. At this point, the valve 22 of the cartridge 20 is fully mated and/or connected with the valve 6 of the fuel cell 10 and two-way fluid communication is possible between the fuel cell 10 and cartridge 20, owing to the valves 22 and 6 being opened. In this pre-transfer position, the fuel cell 10 contains a substantially full electrolyte chamber EC and a substantially full and/or expanded fuel chamber FC. In the case of a used fuel cell 10, these chambers EC and FC contain spent electrolyte and fuel which has been used by fuel cell 10 to produce energy and which can now be transferred from the fuel cell 10 to the cartridge 20. One would not normally need to transfer fuel and electrolyte to the cartridge 20 from the fuel cell 10 unless there is a need to replace the fuel and electrolyte of the fuel cell 10 because of, e.g., the energy production and/or efficiency of the fuel cell 10 having dropped below a desired level. The amount of electrolyte in the chamber EC of the fuel cell 10 prior to transfer will likely be insufficient to fill the chamber CEC, owing to losses (due to e.g., evaporation) which occur in the fuel cell 10. Similarly, the amount of fuel in the chamber FC of the fuel cell 10 prior to transfer will likely be insufficient to fill the chamber CFC, owing to losses (due to e.g., evaporation) which occur in the fuel cell 10. Of course, some small amount of spent fuel and electrolyte may remain in the fuel cell 10 after transfer (see FIGS. 10 and 12), owing to the fact that some fuel and electrolyte will be left in the valve 6 and fluid communication passages of the fuel cell 10.

In the case of a used fuel cell 10 and cartridge 20, the electrolyte chamber EC and the variable volume fuel chamber FC contain the spent fuel and electrolyte and are ready to completely transfer these fluids to the chambers CEC and CFC of the cartridge 20 for disposal, safe-storage, refurbishing, refilling, etc. In other words, the volume and/or space defined by the frame 2, cathode 3 and anode 4 is essentially full electrolyte and the fuel chamber FC is essentially in a fully inflated position and/or defines an upper volume limit (e.g., it has essentially a maximum volume because the flexible material member 5 is in the fully expanded position). This pre-fluid transfer position is also characterized by the plate 21 being in a fully retracted position relative to the rear cover 25 of the cartridge 20 and by the plate 8 being ready to move to a fully retracted position shown in FIGS. 10 and 12.

The fuel cell 10 described above thus includes a flexible and/or variable volume fuel chamber FC and a rigid or fixed volume electrolyte chamber EC. Whenever the fuel cell 10 is not attached and/or connected to the cartridge 20, the fuel chamber FC is at its smallest volume stage. The way in which a volumetric change occurs in the fuel chamber FC is achieved by utilizing a flexible polymer sheet member 5. The sheet member 5 functions as a collapsing compartment and is flexible with regard to its ability to accommodate lesser and greater volumetric changes. The member 5 thus has a preformed shape that relates and follows the fuel cell electrode geometry (which can have, e.g., a rectangular or a circular geometry). The electrode polymeric frame 2 and the flexible sheet 5 form a flexible fuel chamber FC. The flexible compartment or chamber FC can thus change its volume from a minimum volumetric stage whenever it does not contain fuel, to its largest volumetric stage when it extends to contain and/or accommodate the fuel. Whenever the fuel chamber FC is filled with liquid, the chamber FC will extend and/or expand to a bigger volume up to a max predetermined volume and vice versa. The electrolyte compartment or chamber EC, on the other hand, is rigid, i.e., it defines a predetermined fixed volume which does not change and/or remains the same throughout all the fuel cell operational modes.

The cartridge 20 includes a flexible material member 23 that is divided into a number of compartments and/or flexible chambers. This flexible chamber or chamber member 23 can be made of the same material as the fuel cell chamber flexible member 5. In this regard, both flexible members 5 and 23 can be made out of a thin film flexible polymer and has a thickened rim portion 5b and 23b. Accordingly to one non-limiting arrangement, the cartridge 20 includes a plurality of flexible chambers with each chamber having a specific volume. Another possibility is to utilize a single flexible chamber which can be divided into distinct compartments. Of course, the number of chambers can be tailored to specific design requirements. The basic design can also provide for a fuel chamber FC or CFC that may also be divided into two different chambers, which will incorporate the fuel and other fuel components. Another chamber will incorporate the electrolyte. Thus, the invention contemplates an arrangement of the fuel cell 10 and cartridge 20 which can have two, three or even more different compartments. Moreover, as explained above, the liquids stored in the cartridge 20 could be in either fresh or semi-used or used state, dependent on their property and the phase under which they where retracted and/or removed from the fuel cell 10.

Each of the fuel cell 10 and cartridge 20 has a valve 6 and 22. These valves 6 and 22 are configured to be mated to each other. At a pre-mated phase shown in FIGS. 4 and 6, these valves are closed. On the other hand, at full mating phase shown in FIGS. 10 and 12, these valves 6 and 22 are open. The valves 6 and 22 function to open and close one another throughout engagement and disengagement process. Under normal working conditions and whenever the fuel cell 10 and cartridge 20 are not attached to each other (see FIGS. 4 and 6), the valves 6 and 22 are closed. However, when the fuel cell 10 and cartridge 20 are mated, these valves 6 and 22 are open to allow fluid to pass from the cartridge 20 to the fuel cell 10 and vice versa.

In the position shown in FIGS. 4 and 6, the fuel cell is empty, i.e., fluids are absent from both the fuel chamber FC as well as from the electrolyte chamber EC. The fuel chamber FC is at its smallest volumetric size. The cartridge 20, on the other hand, contains the liquids (i.e., the fuel and electrolyte) in chambers CFC and CEC which are at their highest volumetric size. When the cartridge 20 is moved towards the fuel cell 10 in a so-called “engagement phase” (see FIGS. 7 and 9), the valves 6 and 22 are positioned in alignment for mating. At the end of the engagement phase (see FIGS. 10 and 12), both valves 6 and 22 are mated and opened. However, at this point the volumetric state of each compartment and/or chamber EC, FC, CEC and CFC remain unchanged. The next phase which takes place is a so-called “liquid transfer” phase (see FIGS. 13-15). In this phase, liquids from the cartridge 20 are forced by mechanical action to move through the valves 6 and 22 and into the fuel cell compartments or chambers EC and FC. At the end of the liquid transfer phase, the electrolyte substantially fills the electrolyte chamber EC and the fuel substantially fills the fuel chamber FC. This phase also constitutes a so-called “operational phase” of the fuel cell since the cartridge 20 and the fuel cell 10 remain connected to each other during use of the fuel cell to produce energy. The cartridge 20 can be maintained connected to and/or incorporated into the fuel cell 10 by a mechanical connection such as a latch system (not shown). As is apparent from FIGS. 13-15, in the operational phase, the fuel flexible compartment FC extends into the volume of the cartridge 20.

The following two phases occur when the cartridge 20 is to be retracted or disconnected from engagement with the fuel cell 10. A so-called “liquid retraction phase” takes place whereby the semi-used or spent liquids are transferred from the fuel chamber FC and electrolyte chamber EC through the valves 6 and 22 and into corresponding liquid chambers CFC and CEC in the cartridge 20 (see FIGS. 10 and 12). This fluid transfer phase is achieved by mechanical action. At the end of this fluid transfer phase, the cartridge 20 remains attached to the fuel cell 10, but liquid transfer is complete (see FIGS. 10 and 12). A “disconnection phase” can now take place whereby the latch system is released and the cartridge 20 is moved out and away from inside of the fuel cell 10, i.e., the cartridge 20 is disconnected from the fuel cell 10 (see FIGS. 7 and 9). During this disconnection phase, the valves 6 and 22 become disconnected from each other and each valve 6 and 22 closes. At the end of this phase, the cartridge 20 and fuel cell 10 assume a position just like the starting phase with the exception that the fluids in the cartridge 20 are now either semi-used or spent fluids. A fresh cartridge 20 or a semi-used cartridge can now be connected to the fuel cell 10 for further fuel cell operation.

Such an arrangement has the advantage that whenever the cartridge 20 is disengaged from the fuel cell 10, the fuel chamber electrode or anode 4 is not exposed. Moreover, when the semi-used or spent fluids are extracted from the fuel cell 10, both the electrolyte and the fuel are extracted and stored in separated chambers in the cartridge 20. In this way, if and when these fluids are restored into the fuel cell 10, they can be placed therein more easily and completely. The invention even contemplates a cartridge 20 that contains chambers for fresh fuel and electrolyte for transfer to the fuel cell 10 and one or more different chambers for receiving the used fuel-cell liquids.

One non-limiting way in which mechanical action is used to cause the fluids to transfer from the cartridge 20 to the fuel cell 10 provides for actuation by a user. In this case, the user employs force to a lever or a knob (not shown). The knob can be located between members 8 and 21. The force exerted by the knob can be applied directly and/or transferred to member 21 during the refueling stage. This causes compression or a collapsing of the flexible member 23 and the transfer of the fluids from the cartridge 20 to the fuel cell 10. Such an arrangement can also utilize one or more springs arranged within each of the fuel cell 10 and cartridge 20. The springs bias the flexible chambers in a manner which tends to cause the fluids to be placed under pressure so as to cause the fluids to exit out of the fuel cell 10 and cartridge 20 when the springs are set free. In the cartridge 20, for example, the biasing force is exerted on the flexible member 23 directly or through a part, e.g., plate 21, of the cartridge that comes in direct or in an indirect contact with the member 23 in the fluid transfer phase. This biasing forces the fluids to flow out of the cartridge 20. The springs can also be arranged to exerts opposite forces on the cartridge chamber 23, i.e., directed in one direction to achieve the fluid transfer phase and directed in an opposite direction to achieve the fluid retraction phase.

FIG. 16 shows another non-limiting embodiment of a fuel cell 110 and cartridge 120 arrangement. This embodiment uses a cartridge 120 which slides into connection with the fuel cell 110 from a vertical position. The fuel cell 110 includes a projecting lower cradle portion with fluid openings that communicate with the internal chambers of the fuel cell 110. Fuel opening FO communicates with the fuel chamber FC (not shown) and an electrolyte opening EO communicated with electrolyte chamber EC (not shown). These openings are configured to sealing align with and engage with corresponding openings of the cartridge 120 (not shown). The cartridge 120 also includes a lower recessed portion RP which is sized and shaped to slide within and to mate with a cradle recess CR of the fuel cell 110. As with the previous embodiment, the fuel and electrolyte supply chambers of the cartridge 120 are separated from each other and constitute variable volume chambers similar to those of the embodiment shown in FIGS. 1-15. Similarly, the fuel and electrolyte chambers of the fuel cell 110 are separated from each other and constitute defined volume and variable volume chambers similar to those of the fuel cell of the embodiment shown in FIGS. 1-15. The cartridge 120 and fuel cell 110 also utilize internal valves (not shown) which open when the cartridge 120 is fully mated with the fuel cell 110.

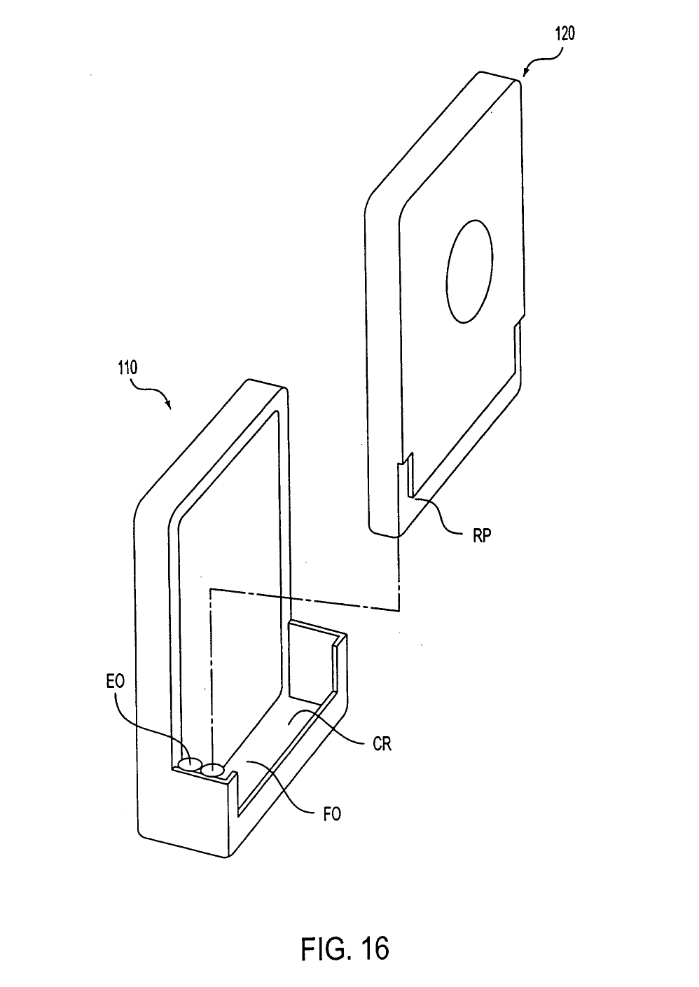

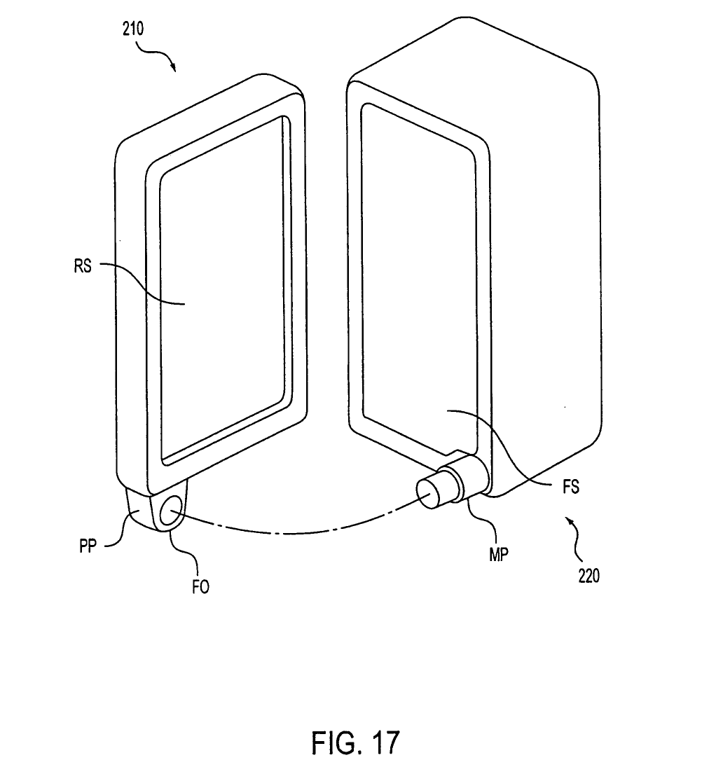

FIG. 17 shows another non-limiting embodiment of a fuel cell 210 and cartridge 220 arrangement. This embodiment uses a cartridge 220 which slides horizontally onto the fuel cell 210 to connect therewith. The fuel cell 210 includes a lower projecting portion PP with a fluid opening that communicate with the internal chambers of the fuel cell 210. Fluid opening FO communicates with the fuel chamber FC (not shown) and with electrolyte chamber EC (not shown). This opening FO is configured to sealing receive and mate with a mating portion MP of the cartridge 220. The cartridge 220 also includes a front surface FS which abuts against a rear surface RS of the fuel cell 210. As with the previous embodiment, the fuel and electrolyte supply chambers of the cartridge 220 are separated from each other and constitute variable volume chambers similar to those of the embodiment shown in FIGS. 1-15. Similarly, the fuel and electrolyte chambers of the fuel cell 210 are separated from each other and constitute defined volume and variable volume chambers similar to those of the fuel cell of the embodiment shown in FIGS. 1-15. The cartridge 220 and fuel cell 210 also utilize internal valves (one arranged within portion MP and another arranged within portion PP) which open when the cartridge 220 is fully mated with the fuel cell 210.

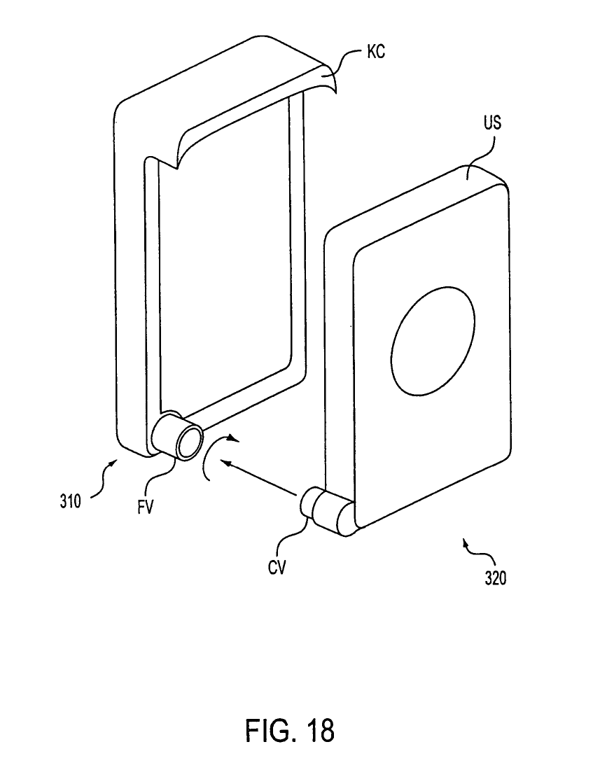

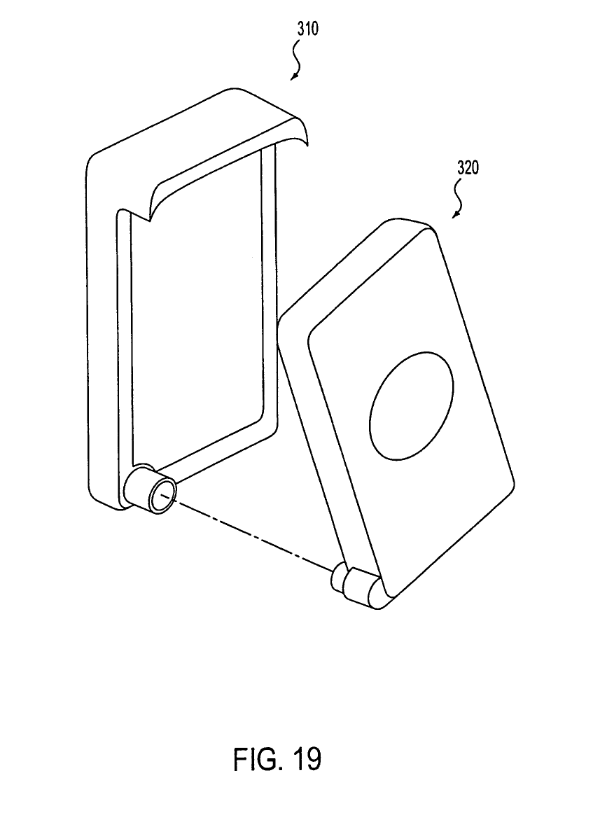

FIGS. 18 and 19 show another non-limiting embodiment of a fuel cell 310 and cartridge 320 arrangement. This embodiment uses a cartridge 320 which slides onto the fuel cell 310 from a horizontal angled position (see FIG. 19) and thereafter rotates to a vertical position. The fuel cell 310 includes a projecting upper cradle portion RC and a fluid valve FV with fluid openings that communicate with the internal chambers of the fuel cell 310. Fuel valve FV communicates with the fuel chamber FC (not shown) and with electrolyte chamber EC (not shown). The valve FV is configured to sealing align with and receive the valve CV of the cartridge 320. The valve CV of the cartridge 320 is sized and shaped to slide within and to mate with the valve FV of the fuel cell 110. Once the cartridge 320 is connected to the fuel cell 310 (which also results in a full connection of the valves FV and CV), the cartridge 320 is rotated until an upper end of the cartridge 320 slides into and otherwise sits within the cradle RC. As with the previous embodiment, the fuel and electrolyte supply chambers of the cartridge 320 are separated from each other and constitute variable volume chambers similar to those of the embodiment shown in FIGS. 1-15. Similarly, the fuel and electrolyte chambers of the fuel cell 310 are separated from each other and constitute defined volume and variable volume chambers similar to those of the fuel cell of the embodiment shown in FIGS. 1-15. The cartridge 320 and fuel cell 310 may also utilize internal valves (not shown) in place of the external valves FV and CV which open when the cartridge 320 is fully mated with the fuel cell 310.

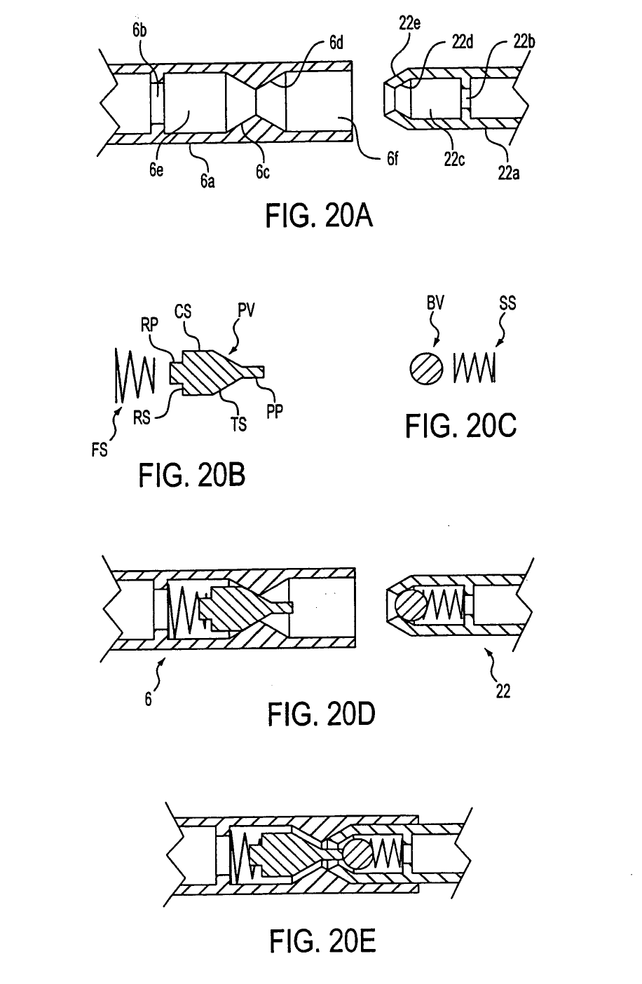

By way of one non-limiting example, the cartridge valve 22 and fuel cell valve 6 may have the arrangement shown in FIGS. 20a-20e. FIG. 20d shows the fuel cell valve 6 and cartridge valve 22 in a state prior to being connected to each other. In this state, the plunger valve PV prevents fluid from exiting the fuel cell 10 by virtue of its tapered surface TS being in sealing contact and/or engagement with correspondingly tapered surface 6c of the valve sleeve 6a. A partially compressed first spring FS acts to bias the plunger valve PV so that sealing contact is maintained between surfaces TS and 6c. The first spring FS is a tapered spring whose larger diameter end is configured to abut against an internal cylindrical shoulder 6d of the sleeve 6a. The smaller diameter portion of the first spring FS is sized to receive therein a rear projection RP of the plunger valve PV and to abut against a rear shoulder RS. The sleeve 6a is generally cylindrical in shape and includes a front cylindrical opening 6f which is sized to receive therein a front cylindrical portion 22a of the cartridge valve 22. In order to ensure that the valve 22 is sealed with respect to the valve 6, the valve 22 includes a tapered surface 22e whose taper corresponds to the tapered surface 6d of the valve 6 (see FIG. 20e). The plunger valve PV and first spring are both arranged within cylindrical section 6e and can move axially within this opening (compare FIGS. 20d and 20e).

In a similar arrangement, a ball valve BV prevents fluid from exiting the cartridge 20 by virtue of its spherical surface being in sealing contact and/or engagement with tapered surface 22d of the valve sleeve 22a. A partially compressed second spring SS acts to bias the ball valve BV so that sealing contact is maintained between the spherical surface of the ball valve BV and tapered surface 22d. The second spring SS is a cylindrical wire spring whose rear end is configured to abut against an internal cylindrical shoulder 22b of the sleeve 22a. The front end of the second spring SS is sized to receive therein a portion of the spherical surface of the ball valve BV (see FIG. 20d). The sleeve 22a is generally cylindrical in shape and includes a front cylindrical opening 22c which is sized to receive therein the ball valve BV and second spring SS. As noted above, the valve 22 can be sealed with respect to the valve 6 when the tapered surface 22e engages the tapered surface 6d of the valve 6 (see FIG. 20e). The ball valve BV and second spring SS are arranged within cylindrical section 22c and can move axially within this opening (compare FIGS. 20d and 20e).

In the position shown in FIG. 20d. the valves 6 and 22 are closed and disconnected from each other. However, in FIG. 20e , the valve 22 has been inserted fully into the valve 6 and both valves 6 and 22 are in an open state to allow fluid communication between the fuel cell 10 and cartridge 20 and vice versa. In this opened position, it can be seen that the small diameter projecting portion PP has forced the ball valve BV to move axially away from sealing engagement with tapered surface 22d. This has occurred by causing the second spring SS to compress even more. Similarly, it can be seen that the biasing forces of the springs FS and SS are such that the second spring SS also forces the plunger valve PV, and specifically surface TS, to move axially away from sealing engagement with tapered surface 6c. This has occurred by causing the first spring FS to compress even more. Although not shown, each valve 6 and 22 may also include therein a sleeve or shoulder which allows the plunger valve PV and/or ball valve BV to move away from sealing engagement only a limited amount, thereby ensuring both valves PV and BV are unseated and placed in the opened position reliably and/or essentially simultaneously.

When it is desired to disconnect the valve 22 from the valve 6, all that is needed is to move valve 22 axially away from valve 6 (or vice versa) to cause the valve 22 to slide out of valve 6. As soon as this occurs, the sealing between surfaces 22e and 6d is broken and the plunger valve PV and ball valve BV will tend to move into sealing engagement with corresponding surfaces 6c and 22d. Thus, fluid is prevented from exiting and/or leaking out of the fuel cell 10 and cartridge 20 by the valves 6 and 22 when they are disconnected (see FIG. 20d). Of course, the valve arrangement shown in FIGS. 20a-20e are but one possible example or embodiments of the valves 6 and 22. The invention contemplates other valve arrangements which allow for the connection and opening of the valves and for the disconnection and closing of the valves. The various parts of the valves 6 and 22 can be made of any desired material whether conventional or otherwise such as metal, plastic, and/or composites. Additionally, the invention may also utilize valves similar to those used in copending application P25032 (attorney docket number) filed on Mar. 10, 2004 and based upon Provisional Application No. 60/453,218 filed on Mar. 11, 2003, the disclosures of which are hereby expressly incorporated by reference herein in their entireties.

It is noted that the cartridge 20 or refilling device can be disposable and is preferably made of light-weight materials. It should also be noted that the exemplary dimensions, values, sizes, volumes, etc., disclosed herein are not intended to be limiting and may vary by as much as, e.g., 50% less to 150% more. Moreover, it should be noted that one way that the spent fluids of the cartridge 20 can be recycled is to remove the valve and allowing the contents to exit from cartridge 20. The majority of parts of the cartridge can be made of polymer materials which are suitable for the fuel cell environment and which can withstand contact/exposure with fuel and electrolyte from a fuel cell and/or similar chemicals. Examples of non-limiting polymer materials include PVC, PP and polyurethane, etc.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A fuel cell system comprising:
a fuel cell comprising at least one variable volume chamber;
a cartridge comprising at least one variable volume chamber; and
a valve system which regulates or controls fluid flow between the cartridge and fuel cell and vice versa.

2. The system of claim 1, wherein the at least one variable volume chamber of the fuel cell comprises a flexible fuel chamber.

3. The system of claim 1, further comprising an electrolyte chamber having a defined volume.

4. The system of claim 1, further comprising an electrolyte chamber.

5. The system of claim 1, wherein the at least one variable volume chamber of the cartridge comprises a flexible fuel chamber.

6. The system of claim 1, wherein the at least one variable volume chamber of the cartridge comprises a flexible fuel chamber and a flexible electrolyte chamber.

7. The system of claim 1, wherein the at least one variable volume chamber of the fuel cell comprises a flexible wall having folds.

8. The system of claim 1, wherein the at least one variable volume chamber of the cartridge comprises a flexible wall having folds.

9. The system of claim 1, wherein the at least one variable volume chamber of the fuel cell comprises a flexible expandable and contractable chamber.

10. The system of claim 1, wherein the at least one variable volume chamber of the cartridge comprises a flexible expandable and contractable chamber.

11. The system of claim 1, wherein the cartridge is removably connected to the fuel cell.

12. The system of claim 11, wherein the cartridge is removably connected to the fuel cell by a sliding connection.

13. The system of claim 11, wherein the cartridge is removably connected to the fuel cell by a sliding cradle connection.

14. The system of claim 11, wherein the cartridge is removably connected to the fuel cell by an abutting connection.

15. The system of claim 11, wherein the cartridge is removably connected to the fuel cell by a rotational sliding connection.

16. The system of claim 1, wherein the fuel cell further comprises a front cover, a rear cover, a mounting frame, an anode assembly, a cathode assembly, a cathode protection device, and a frame rim.

17. The system of claim 16, wherein the at least one variable volume chamber of the fuel cell comprises a flexible wall having folds and a peripheral rim secured to the anode assembly.

18. The system of claim 16, wherein the cathode protection device comprises a cathode protection net.

19. The system of claim 16, wherein the anode assembly and the cathode assembly are mounted to the mounting frame and wherein a volume defined by the mounting frame, the anode assembly and the cathode assembly forms an electrolyte chamber.

20. The system of claim 16, wherein the at least one variable volume chamber of the fuel cell comprises a flexible wall having folds and a peripheral rim secured to the anode assembly and wherein a volume defined by the flexible wall and the anode assembly forms the at least one variable volume chamber of the fuel cell.

21. The system of claim 1, wherein the cartridge further comprises a front cover and a rear cover.

22. The system of claim 21, wherein the at least one variable volume chamber of the cartridge is disposed between the front cover and the rear cover.

23. The system of claim 1, wherein the at least one variable volume chamber of the cartridge comprises a backing and a flexible wall having folds and a peripheral portion secured to the backing.

24. The system of claim 23, wherein the backing comprises a plate.

25. The system of claim 1, wherein the at least one variable volume chamber of the cartridge comprises a variable volume fuel chamber and a variable volume electrolyte chamber, and further comprising fuel arranged within the variable volume fuel chamber and electrolyte arranged within the variable volume electrolyte chamber.

26. The system of claim 1, wherein the at least one variable volume chamber of the fuel cell comprises a variable volume fuel chamber, and wherein the fuel cell further comprises an electrolyte chamber, fuel arranged within the variable volume fuel chamber, and electrolyte arranged within the electrolyte chamber.

27. The system of claim 1, wherein the valve system comprises a first part which is coupled to and/or associated with the fuel cell and a second part which is coupled to and/or associated with the cartridge.

28. The system of claim 27, wherein the second part is insertable into the first part.

29. The system of claim 27, wherein the second part is releasably connectable to the first part.

30. The system of claim 27, wherein, when the second part is disconnected from the first part, the first part prevents fluid from exiting out of the fuel cell and the second part prevents fluid from exiting out of the cartridge.

31. The system of claim 27, wherein, when the second part is disconnected from the first part, the first part prevents fluid from leaking out of the fuel cell and the second part prevents fluid from leaking out of the cartridge.

32. The system of claim 1, wherein the valve system comprises a closed position and an opened position.

33. The system of claim 1, wherein the valve system comprises a plurality of exit ports which are in fluid communication with the fuel cell.

34. The system of claim 1, wherein the fuel cell and cartridge each comprise a generally rectangular shape.

35. A method of assembling a cartridge to a fuel cell, the method comprising:
connecting a cartridge comprising at least one variable volume chamber to a fuel cell comprising at least one variable volume chamber; and
transferring fluid from the cartridge to the fuel cell.

36. The method of claim 35, wherein the transferring comprises regulating or controlling fluid flow between the cartridge and fuel cell.

37. The method of claim 35, wherein the transferring comprises regulating or controlling fluid flow between the cartridge and fuel cell and vice versa.

38. The method of claim 35, further comprising transferring spent fluid between the fuel cell and the cartridge.

39. The method of claim 35, further comprising controlling fluid flow between the cartridge and the fuel cell via a valve system.

40. The method of claim 35, further comprising controlling fluid flow between the fuel cell and the cartridge via a valve system.

41. The method of claim 35, wherein the transferring comprises compressing the least one variable volume chamber of the cartridge to cause the fluid to enter into the fuel cell.

42. The method of claim 41, wherein the fluid comprises fuel and electrolyte.

43. The method of claim 35, wherein the transferring comprises forcing the fluid to enter into the at least one variable volume chamber of the fuel cell from the at least one variable volume chamber of the cartridge.

44. The method of claim 35, wherein the at least one variable volume chamber of the fuel cell comprises a flexible wall with folds.

45. The method of claim 35, wherein the at least one variable volume chamber of the cartridge comprises a flexible wall with folds.

46. The method of claim 35, wherein the at least one variable volume chamber of the fuel cell comprises a flexible expandable and contractable chamber.

47. The method of claim 35, wherein the at least one variable volume chamber of the cartridge comprises a flexible expandable and contractable chamber.

48. The method of claim 35, further comprising, before the transferring, coupling a valve of the cartridge to a valve of the fuel cell.

49. The method of claim 48, further comprising, before the transferring, causing each valve to open from a closed position to allow fluid communication between the cartridge and the fuel cell.

50. The method of claim 35, further comprising controlling fluid flow between the cartridge and the fuel cell and vice versa with a valve arrangement.

51. The method of claim 35, further comprising, before the transferring, securely attaching a male valve portion on the cartridge to a female valve portion on the fuel cell.

52. The method of claim 35, further comprising, after the transferring, transferring spent fluid from the fuel cell to the cartridge and disconnecting the cartridge from the fuel cell.

53. The method of claim 52, further comprising, after the disconnecting, connecting a new cartridge to the fuel cell.

54. A cartridge for refilling a fuel cell, the cartridge comprising:
a main container;
at least one variable volume fuel chamber and at least one variable volume electrolyte chamber arranged within the main container; and
a valve that communicates with the at least one variable volume fuel and electrolyte chambers.

55. The cartridge of claim 54, wherein the main container comprises a rear cover and a front cover.

56. The cartridge of claim 54, wherein the at least one variable volume fuel chamber comprises an flexible material wall that is at least one of expandable and compressible and inflatable and deflatable.

57. The cartridge of claim 54, wherein the at least one variable volume electrolyte chamber comprises an flexible material wall that is at least one of expandable and compressible and inflatable and deflatable.

58. The cartridge of claim 54, wherein the at least one variable volume fuel chamber is defined by an inflatable and/or expandable flexible material wall and a rigid plate.

59. The cartridge of claim 58, wherein the at least one variable volume electrolyte chamber is defined by another inflatable and/or expandable flexible material wall and the rigid plate.

60. The cartridge of claim 54, wherein the at least one variable volume electrolyte chamber is defined by an inflatable and/or expandable flexible material wall and a rigid plate.

61. The cartridge of claim 54, wherein the at least one variable volume fuel chamber comprises a flexible material wall with folds.

62. The cartridge of claim 54, wherein the at least one variable volume electrolyte chamber comprises a flexible material wall with folds.

63. The cartridge of claim 54, wherein the main container completely surrounds and contains the at least one variable volume fuel chamber and the at least one variable volume electrolyte chamber.

64. The cartridge of claim 54, wherein the at least one variable volume fuel chamber and the at least one variable volume electrolyte chamber are separated from each other.

65. The cartridge of claim 54, further comprising fuel arranged within the at least one variable volume fuel chamber and electrolyte arranged within the at least one variable volume electrolyte chamber.

66. The cartridge of claim 54, wherein the valve is adapted to prevent fuel and electrolyte from exiting the at least one variable volume fuel chamber and the at least one variable volume electrolyte chamber when the cartridge is separated from the fuel cell, and wherein the valve is adapted to allow fuel and electrolyte to exit from the at least one variable volume fuel chamber and the at least one variable volume electrolyte chamber when the cartridge is connected to the fuel cell.

67. The cartridge of claim 54, wherein the valve is adapted to prevent fuel and electrolyte from exiting the at least one variable volume fuel chamber and the at least one variable volume electrolyte chamber when the valve is disconnected from a valve of the fuel cell, and wherein the valve is adapted to allow fuel and electrolyte to exit from the at least one variable volume fuel chamber and the at least one variable volume electrolyte chamber when the valve of the cartridge is connected to the valve of the fuel cell.

68. The cartridge of claim 54, wherein the valve is adapted to connect to and disconnect from a valve of the fuel cell.

69. The cartridge of claim 54, wherein the valve comprises a closed position and an opened position.

70. The cartridge of claim 54, wherein the valve comprises a plurality of exit ports which are adapted for fluid communication with the fuel cell.

71. The cartridge of claim 54, further comprising a securing cap that is removably secured to the valve.

72. A fuel cell adapted to connect to a cartridge, the fuel cell comprising:
an outer shell;
at least one variable volume fuel chamber and at least one electrolyte chamber arranged within the outer shell;
an anode arranged within the outer shell;
a cathode arranged within the outer shell; and
a valve that communicates with the at least one variable volume fuel and electrolyte chambers.

73. The fuel cell of claim 72, wherein the outer shell comprises a rear cover and a front cover.

74. The fuel cell of claim 72, wherein the at least one variable volume fuel chamber comprises an flexible material wall that is at least one of expandable and compressible and inflatable and deflatable.

75. The fuel cell of claim 72, wherein the at least one electrolyte chamber comprises a defined volume chamber.

76. The fuel cell of claim 72, wherein the at least one variable volume fuel chamber is defined by an inflatable and/or expandable flexible material wall and a rigid plate member.

77. The fuel cell of claim 76, wherein the rigid plate member comprises the anode.

78. The fuel cell of claim 72, wherein the at least one electrolyte chamber is defined by the cathode.

79. The fuel cell of claim 78, wherein the at least one electrolyte chamber is defined by the cathode and a frame member.

80. The fuel cell of claim 72, wherein the at least one variable volume fuel chamber comprises a flexible material wall with folds.

81. The fuel cell of claim 72, further comprising a frame member supporting the anode and the cathode.

82. The fuel cell of claim 72, wherein the outer shell completely surrounds and contains the at least one variable volume fuel chamber and the at least one electrolyte chamber.

83. The fuel cell of claim 72, wherein the at least one variable volume fuel chamber and the at least one electrolyte chamber are separated from each other.

84. The fuel cell of claim 72, further comprising fuel arranged within the at least one variable volume fuel chamber and electrolyte arranged within the at least one electrolyte chamber.

85. The fuel cell of claim 72, wherein the valve is adapted to prevent fuel and electrolyte from exiting the at least one variable volume fuel chamber and the at least one electrolyte chamber when the fuel cell is separated from a cartridge, and wherein the valve is adapted to allow fuel and electrolyte to exit from the at least one variable volume fuel chamber and the at least one electrolyte chamber when the cartridge is connected to the fuel cell.

86. The fuel cell of claim 72, wherein the valve is adapted to prevent fuel and electrolyte from exiting the at least one variable volume fuel chamber and the at least one electrolyte chamber when the valve is disconnected from a valve of the cartridge, and wherein the valve is adapted to allow fuel and electrolyte to exit from the at least one variable volume fuel chamber and the at least one electrolyte chamber when the valve of the cartridge is connected to the valve of the fuel cell.

87. The fuel cell of claim 72, wherein the valve is adapted to connect to and disconnect from a valve of the cartridge.

88. The fuel cell of claim 72, wherein the valve comprises a closed position and an opened position.

89. The fuel cell of claim 72, wherein the valve comprises a plurality of exit ports which are adapted for fluid communication with the cartridge.

90. The fuel cell of claim 72, further comprising a securing cap that is removably secured to the valve.

91. A fuel cell and cartridge system, the system comprising:
a fuel cell comprising, an anode, a cathode, at least one variable volume fuel chamber, at least one electrolyte chamber, and a first valve which regulates or controls fluid flow; and
a cartridge comprising at least one variable volume fuel chamber, at least one variable volume electrolyte chamber, and a second valve which regulates or controls fluid flow,
wherein the second valve is removably connectable to the first valve.

92. The system of claim 91, wherein the fuel cell comprises an outer shell having a rear cover and a front cover.

93. The system of claim 91, wherein each at least one variable volume fuel chamber comprises an flexible material wall that is at least one of expandable and compressible and inflatable and deflatable.

94. The system of claim 91, wherein the at least one electrolyte chamber of the fuel cell comprises a defined volume chamber.

95. The system of claim 91, wherein each at least one variable volume fuel chamber is defined by an inflatable and/or expandable flexible material wall and a rigid plate member.

96. The system of claim 91, wherein the at least one electrolyte chamber of the fuel cell is defined by the cathode and a frame member.

97. The system of claim 91, wherein each at least one variable volume fuel chamber comprises a flexible material wall with folds.

98. The system of claim 91, further comprising a frame member supporting the anode and the cathode of the fuel cell.

99. The system of claim 91, wherein the fuel cell further comprises an outer shell that completely surrounds and contains the at least one variable volume fuel chamber and the at least one electrolyte chamber.

100. The system of claim 91, wherein the cartridge further comprises a main container that completely surrounds and contains the at least one variable volume fuel chamber and the at least one variable volume electrolyte chamber.

101. The system of claim 91, wherein the at least one variable volume fuel chamber and the at least one electrolyte chamber of the fuel cell are separated from each other, and wherein the at least one variable volume fuel chamber and the at least one variable volume electrolyte chamber of the cartridge are separated from each other.

102. The system of claim 91, further comprising fuel arranged within the at least one variable volume fuel chamber and electrolyte arranged within the at least one electrolyte chamber of the fuel cell.

103. The system of claim 91, further comprising fuel arranged within the at least one variable volume fuel chamber and electrolyte arranged within the at least one variable volume electrolyte chamber of the cartridge.

104. The system of claim 91, wherein the first valve is adapted to prevent fuel and electrolyte from exiting the at least one variable volume fuel chamber and the at least one electrolyte chamber when the fuel cell is separated from the cartridge, and wherein the second valve is adapted to allow fuel and electrolyte to exit from the at least one variable volume fuel chamber and the at least one variable volume electrolyte chamber of the cartridge when the cartridge is connected to the fuel cell.

105. The system of claim 91, wherein the first valve is adapted to prevent fuel and electrolyte from exiting the at least one variable volume fuel chamber and the at least one electrolyte chamber when the first valve is disconnected from the second valve of the cartridge, and wherein the first valve is adapted to allow fuel and electrolyte to exit from the at least one variable volume fuel chamber and the at least one electrolyte chamber when the second valve of the cartridge is connected to the first valve of the fuel cell.

106. The system of claim 91, wherein the first valve of the fuel cell is adapted to connect to and disconnect from the second valve of the cartridge.

107. The system of claim 91, wherein each of the first and second valves comprises a closed position and an opened position.

108. The system of claim 91, wherein each of the first and second valves comprise a plurality of exit ports which are adapted for fluid flow.

109. The system of claim 91, further comprising a first securing cap that is removably secured to the first valve and a second securing cap that is removably secured to the second valve.

110. The system of claim 91, wherein the first valve is securely and sealingly connected to second valve.

111. A method of refilling a fuel cell using the system of claim 91, the method comprising:
connecting the second valve of the cartridge to the first valve of the fuel cell;
forcing fuel to enter into the at least one variable volume fuel chamber of the fuel cell from the at least one variable volume fuel chamber of the cartridge; and
forcing electrolyte to enter into the at least one electrolyte chamber of the fuel cell from the at least one variable volume electrolyte chamber of the cartridge.

112. The method of claim 111, wherein each forcing comprises compressing the at least one variable volume fuel chamber and the at least one variable volume electrolyte chamber to cause fuel and electrolyte to enter into the fuel cell.

113. The method of claim 111, further comprising controlling fluid flow between the fuel cell and cartridge with the first and second valves.

114. The method of claim 111, further comprising controlling fluid flow between the fuel cell and the cartridge with the first and second valves.

115. The method of claim 111, further comprising:
forcing fuel to enter into the at least one variable volume fuel chamber of the cartridge from the at least one variable volume fuel chamber of the fuel cell;
forcing electrolyte to enter into the at least one variable volume electrolyte chamber of the cartridge from the at least one electrolyte chamber of the fuel cell;
disconnecting the second valve from the first valve; and
preventing, with the second valve, spent fuel and electrolyte from exiting the cartridge.

116. A method of refilling a fuel cell with a removable cartridge, the method comprising:
connecting the cartridge and the fuel cell to each other; and
transferring at least one fuel component from the cartridge to the fuel cell.

117. The method of claim 116, further comprising:
transferring the at least one fuel component from the fuel cell to the cartridge; and
disconnecting the cartridge from the fuel cell.
